(19) United States
(12) Patent Application Publication
(10) Pub. No.: US 2026/0016773 A1
(43) Pub. Date: Jan. 15, 2026

(54) TONER CARTRIDGE AND IMAGE FORMING APPARATUS

(71) Applicant: CANON KABUSHIKI KAISHA, Tokyo (JP)

(72) Inventors: TORU OGUMA, Shizuoka (JP); TATSURO HARADA, Shizuoka (JP); KAZUTAKA SUESHIGE, Shizuoka (JP); KAZUKI MATSUMOTO, Shizuoka (JP)

(21) Appl. No.: 19/327,058

(22) Filed: Sep. 12, 2025

Related U.S. Application Data
(63) Continuation of application No. PCT/JP2024/080023, filed on Mar. 7, 2024.

(30) Foreign Application Priority Data
Mar. 14, 2023 (JP) 2023-040177
Mar. 14, 2023 (JP) 2023-040178

(51) Int. Cl. G03G 15/08; G03G 21/18; G03G 21/20

(52) U.S. Cl. CPC G03G 15/0886; G03G 15/0875; G03G 15/0879; G03G 21/1814; G03G 21/206

(57) ABSTRACT

A toner cartridge is provided with a toner accommodating chamber configured to accommodate toner, a filter including an opening portion and configured to restrict passage of the toner and permit passage of air in a region excluding the opening portion and an air chamber provided with a receiving opening for receiving the air and adjacent to the toner accommodating chamber via the filter. The opening portion discharges the toner in the toner accommodating chamber toward an outside of the toner cartridge.

### TECHNICAL FIELD

The present invention relates to a toner cartridge which accommodates toner and an image forming apparatus provided with the toner cartridge.

### BACKGROUND ART

According to Japanese Patent Application Laid-Open No. 2000-147884, an image forming apparatus provided with a developing device which accommodates toner, a toner accommodating container which accommodates the toner to be supplied to the developing device, and an air pump which feeds air to the toner accommodating container is disclosed. To the toner accommodating container, a toner discharging tube and a gap for air are provided, and when air is fed from the air pump to the gap for air, pressure inside the toner accommodating container is increased and the toner is discharged from the toner discharging tube.

### SUMMARY OF THE INVENTION

### Problem to be Solved by the Invention

A mode of a toner cartridge which conveys toner with air and a mode of an image forming apparatus provided with the toner cartridge are provided.

### Means for Solving the Problem

The present invention is a toner cartridge comprising: a toner accommodating chamber configured to accommodate toner; a filter including an opening portion and configured to restrict passage of the toner and permit passage of air in a region excluding the opening portion; and an air chamber provided with a receiving opening for receiving the air and adjacent to the toner accommodating chamber via the filter, wherein the opening portion discharges the toner in the toner accommodating chamber toward an outside of the toner cartridge.

### Effect of the Invention

According to the present invention, it becomes possible to provide a form of a toner cartridge which conveys toner with air and a form of an image forming apparatus provided with the toner cartridge.

### BRIEF DESCRIPTION OF THE DRAWINGS

FIG. 1 is an overall outline view illustrating an image forming apparatus according to an Embodiment 1.

FIG. 2 is a cross-sectional view illustrating a process cartridge.

Part (a) of FIG. 3 includes a cross-sectional view illustrating a toner cartridge and an enlarged view of a portion thereof, and part (b) of FIG. 3 is a cross-sectional view illustrating a 3B-3B cross-section in part (a) of FIG. 3.

Part (a) of FIG. 4 is a view illustrating an initial state in which toner in a toner accommodating chamber is not discharged, part (b) of FIG. 4 is a view illustrating a state in which the toner in the toner accommodating chamber is being discharged, part (c) of FIG. 4 is a view illustrating a state in which the toner in the toner accommodating chamber is further being discharged, and part (d) of FIG. 4 is a view illustrating a state in which the toner in the toner accommodating chamber is further being discharged.

FIG. 5 includes a cross-sectional view illustrating a Modified Example 1 of the Embodiment 1 and an enlarged view of a portion thereof.

Part (a) of FIG. 6 includes a cross-sectional view illustrating a pressure response portion in a first state and an enlarged view of a portion thereof, part (b) of FIG. 6 includes a cross-sectional view illustrating the pressure response portion in a second state and an enlarged view of a portion thereof, and part (c) of FIG. 6 is a view illustrating a Modified Example 2 of the Embodiment 1.

Part (a) of FIG. 7 is a cross-sectional view illustrating the process cartridge, and part (b) of FIG. 7 is a view of the process cartridge as viewed in a direction of gravity.

FIG. 8 is a view illustrating a Modified Example 3 of the Embodiment 1.

FIG. 9 is a view illustrating a toner sealing configuration in the process cartridge.

FIG. 10 is a view illustrating the toner sealing configuration in the image forming apparatus.

Part (a) of FIG. 11 is a cross-sectional view illustrating a toner cartridge according to an Embodiment 2, and part (b) of FIG. 11 is a cross-sectional view illustrating a Modified Example of a guide member.

Part (a) of FIG. 12 is a cross-sectional view illustrating a toner cartridge according to an Embodiment 3, and part (b) of FIG. 12 is a cross-sectional view illustrating a Modified Example of a guide member.

Part (a) of FIG. 13 is a cross-sectional view illustrating a toner cartridge according to an Embodiment 4, and part (b) of FIG. 13 is a cross-sectional view illustrating a Modified Example of a guide member.

FIG. 14 is a cross-sectional view illustrating a toner cartridge according to an Embodiment 5.

FIG. 15 is a cross-sectional view illustrating a toner cartridge according to an Embodiment 6.

Part (a) of FIG. 16 includes a cross-sectional view illustrating a pressure response portion in a first state according to an Embodiment 7 and an enlarged view of a portion thereof, and part (b) of FIG. 16 includes a cross-sectional view illustrating the pressure response portion in a second state and an enlarged view of a portion thereof.

Part (a) of FIG. 17 includes a cross-sectional view illustrating a pressure response portion in a first state according to an Embodiment 8 and an enlarged view of a portion thereof, and part (b) of FIG. 17 includes a cross-sectional view illustrating the pressure response portion in a second state and an enlarged view of a portion thereof.

Part (a) of FIG. 18 includes a cross-sectional view illustrating a pressure response portion in a first state according to an Embodiment 9 and an enlarged view of a portion thereof, and part (b) of FIG. 18 includes a cross-sectional view illustrating the pressure response portion in a second state and an enlarged view of a portion thereof.

FIG. 19 includes a cross-sectional view illustrating a pressure response portion according to an Embodiment 10 and an enlarged view of a portion thereof.

Part (a) of FIG. 20 includes a cross-sectional view illustrating a toner cartridge according to an Embodiment 11 and an enlarged view of a portion thereof, and part (b) of FIG. 20 includes a cross-sectional view illustrating a toner cartridge according to a Modified Example of the Embodiment 11 and an enlarged view of a portion thereof.

FIG. 21 is an overall outline view of the image forming apparatus according to the Embodiment 12.

FIG. 22 is a cross-sectional view illustrating the process cartridge.

Part (a) of FIG. 23 is a cross-sectional view illustrating a toner cartridge, a pump and a valve unit when the pump is contracted, and part (b) of FIG. 23 is a cross-sectional view illustrating the toner cartridge, the pump and the valve unit when the pump is extended.

Part (a) of FIG. 24 is a view illustrating an initial state in which toner in a toner accommodating chamber is not discharged, part (b) of FIG. 24 is a view illustrating a state in which the toner in the toner accommodating chamber is being discharged, part (c) of FIG. 24 is a view illustrating a state in which the toner in the toner accommodating chamber is further being discharged, and part (d) of FIG. 24 is a view illustrating a state in which the toner in the toner accommodating chamber is further being discharged.

FIG. 25 is a cross-sectional view illustrating a process cartridge according to the Embodiment 13.

Part (a) of FIG. 26 is a cross-sectional view illustrating a toner cartridge and a peripheral configuration thereof according to the Embodiment 14, and part (b) of FIG. 26 is a cross-sectional view illustrating the toner cartridge and the peripheral configuration thereof.

### EMBODIMENTS FOR CARRYING OUT THE INVENTION

### Embodiment 1

### [Overall Configuration]

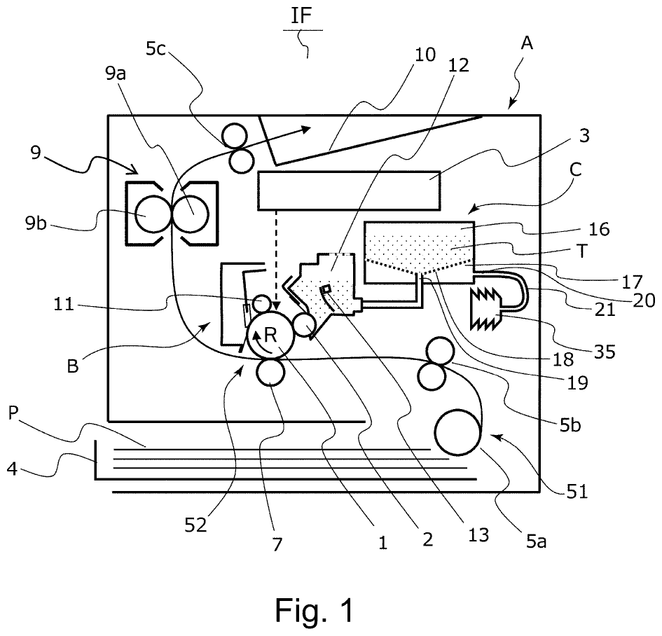

First, an Embodiment 1 of the present invention will be described. An image forming apparatus IF according to the Embodiment 1 is a laser beam printer of an electrophotographic type. The image forming apparatus IF includes, as shown in FIG. 1, a main assembly A, a process cartridge B and a toner cartridge C, and the process cartridge B and the toner cartridge C are detachably provided to the main assembly A. In the present Embodiment, the main assembly A refers to a portion of the image forming apparatus IF excluding the process cartridge B and the toner cartridge C.

Incidentally, the image forming apparatus includes a printer, a copy machine, a facsimile machine and a multifunction machine, and shall refer to any apparatus, which forms an image on a sheet used as a recording medium based on image information input from an external PC or image information read from an original. In addition, to the image forming apparatus, in addition to the main assembly having an image forming function, an accessory device such as an optional feeder, an image reading apparatus, a sheet processing apparatus may be connected, however, an entire system in which such an accessory device is connected is also one type of the image forming apparatus. In addition, in the present Embodiment, the sheet includes a paper such as a sheet and an envelope, a plastic film such as a sheet for an overhead projector (OHP), cloth, etc.

The image forming apparatus IF includes a sheet feeding portion 51 which feeds a stacked sheet and an image forming portion 52 which forms the image on the fed sheet. In addition, the image forming apparatus IF includes a fixing device 9 which fixes the image transferred onto the sheet to the sheet, a discharging roller pair 5c capable of discharging the sheet to a discharge tray 10, a pump 35 and the toner cartridge C.

When a command for image formation is output to the image forming apparatus IF, based on the image information input from the external computer connected to the image forming apparatus IF, etc., an image forming process by the image forming portion 52 is started. The image forming portion 52 includes the process cartridge B, a laser scanner 3 and a transfer roller 7. The process cartridge B includes a photosensitive drum 1 which is rotated in a direction of an arrow R, a charging roller 11 and a developing roller 2 disposed along the photosensitive drum 1, a toner chamber 12 which accommodates toner to be supplied to the developing roller 2, and a stirring member 13.

The laser scanner 3 emits, based on the input image information, a laser light toward the photosensitive drum 1. At this time, the photosensitive drum 1 is charged in advance by the charging roller 11, and by being irradiated by the laser light, an electrostatic latent image is formed on the photosensitive drum 1. The toner accommodated in the toner chamber 12 is stirred by the stirring member 13 and is supplied to the developing roller 2. Thereafter, the electrostatic latent image is developed by the developing roller 2, and a monochrome toner image is formed on the photosensitive drum 1.

In parallel with the above-described image forming process, a sheet P is fed from the sheet feeding portion 51. The sheet feeding portion 51 includes a sheet tray 4 on which the sheets P are stacked and a pickup roller 5a. The sheet P supported by the sheet tray 4 is fed by the pickup roller 5a. The sheet P fed by the pickup roller 5a is conveyed by a conveyance roller pair 5b. Incidentally, the conveyance roller pair 5b may be constituted by a registration roller pair which corrects oblique movement of the sheet P and adjusts a conveyance timing for the sheet P.

To the sheet P conveyed by the conveyance roller pair 5b, by an electrostatic load bias applied to the transfer roller 7, the toner image on the photosensitive drum 1 is transferred. To the sheet Ponto which the toner image has been transferred, predetermined heat and pressure are applied by a heating roller 9a and a pressing roller 9b of the fixing device 9, and the toner is melted and fixedly adhered (fixed) to the sheet P. The sheet P which has passed through the fixing device 9 is conveyed to the discharging roller pair 5c and discharged to the discharge tray 10 by the discharging roller pair 5c.

### [Process Cartridge]

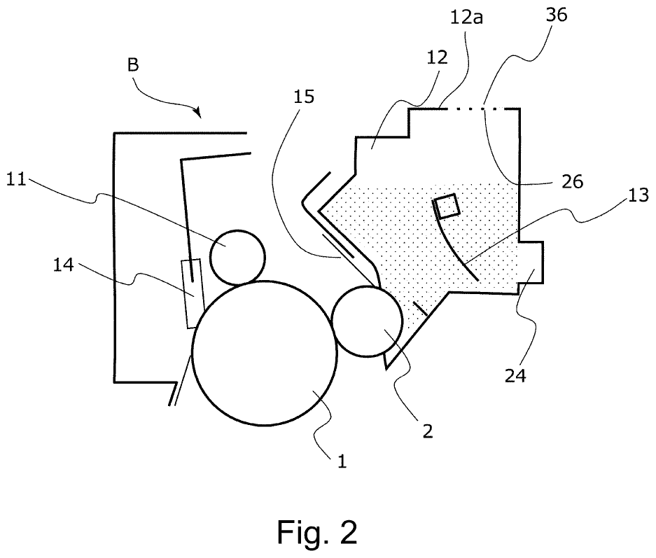

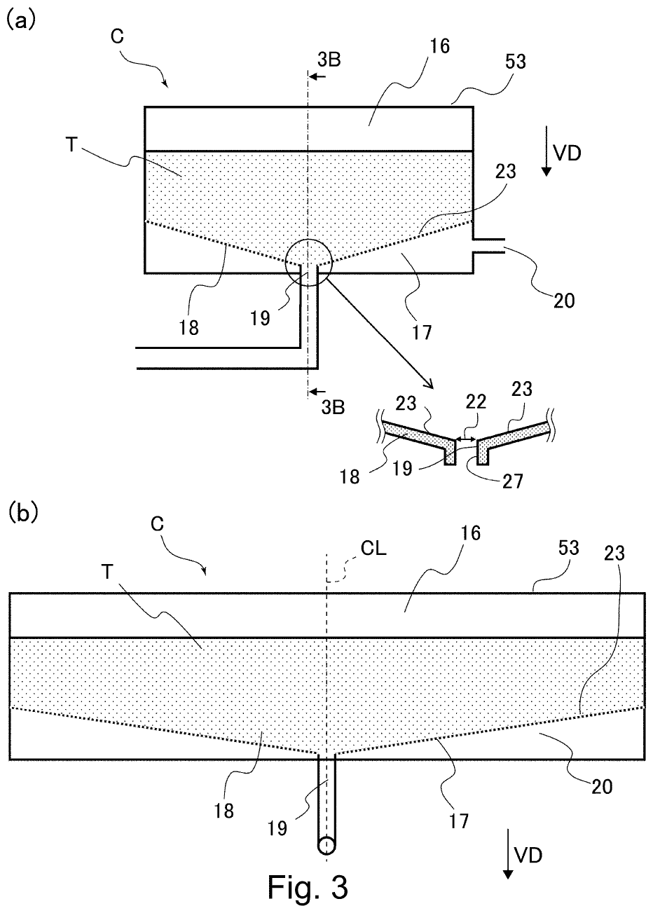

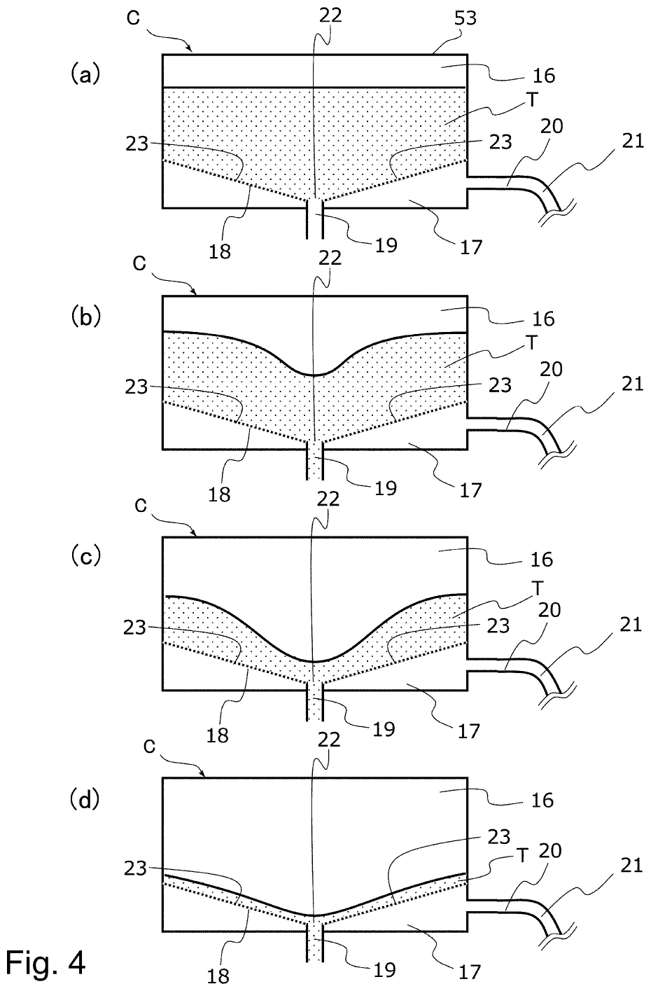

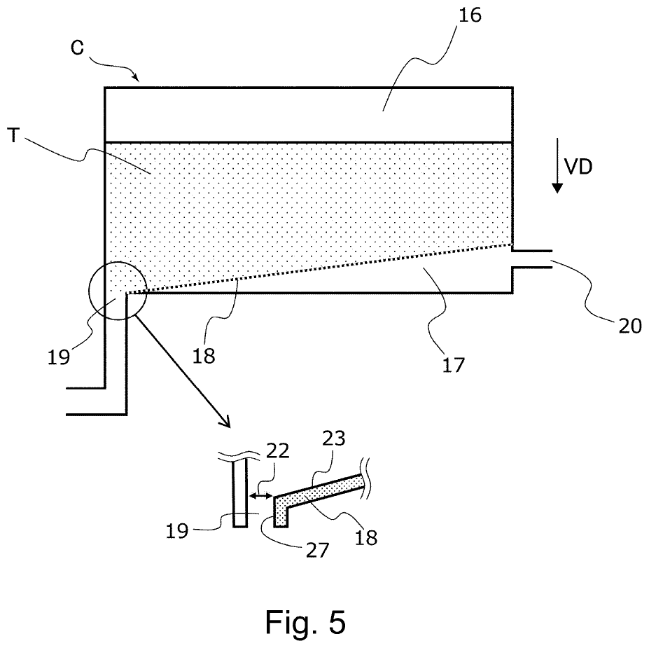

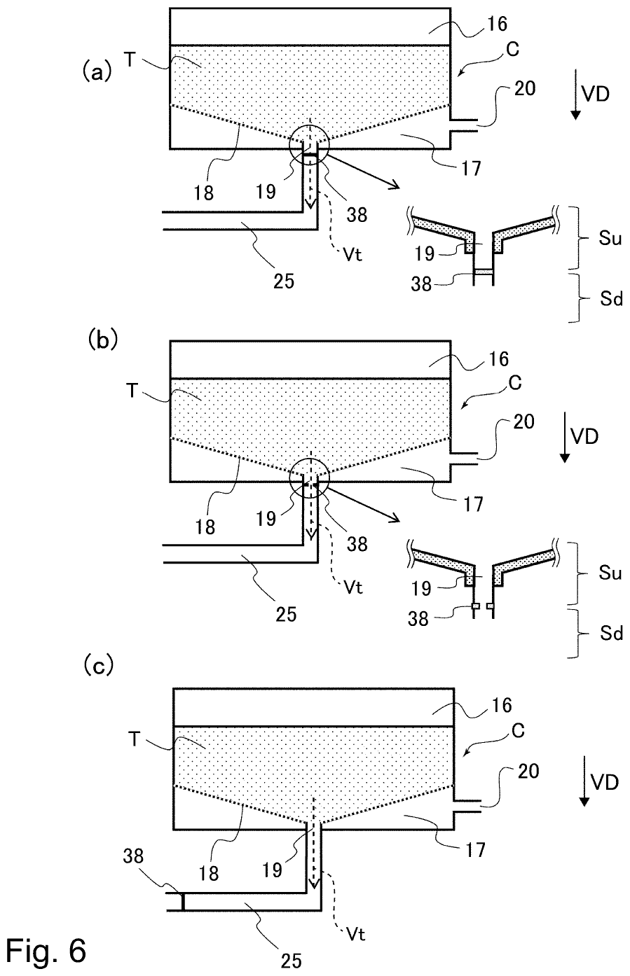

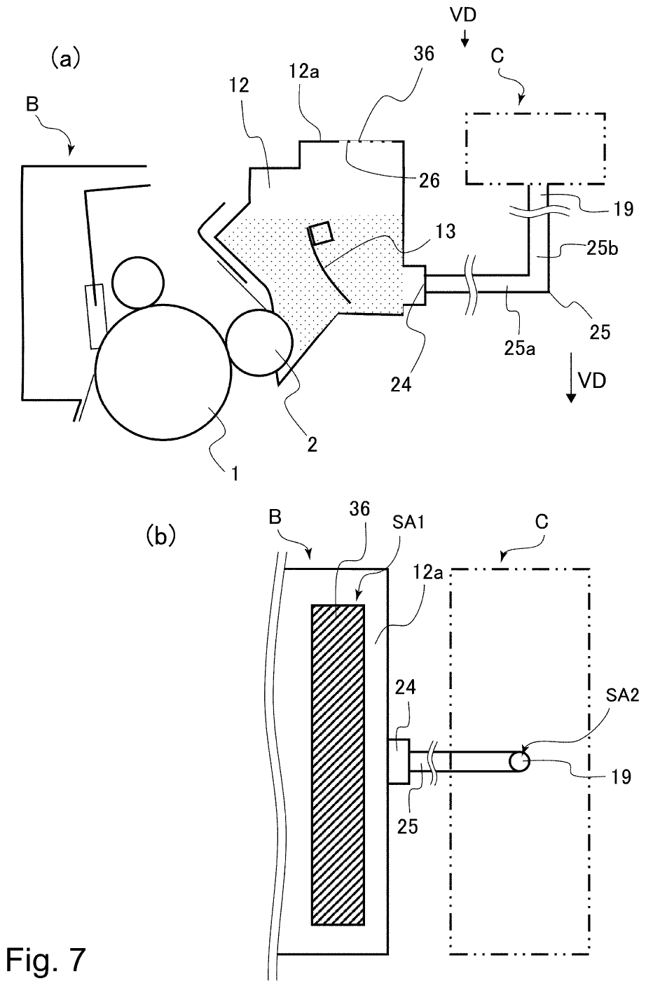

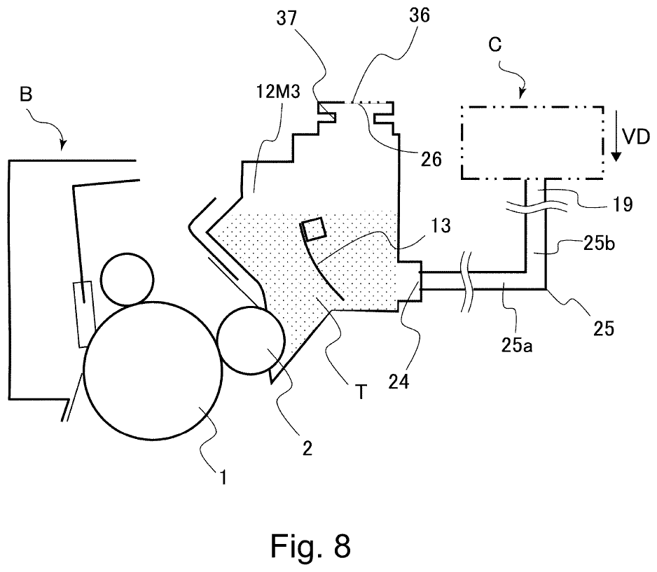

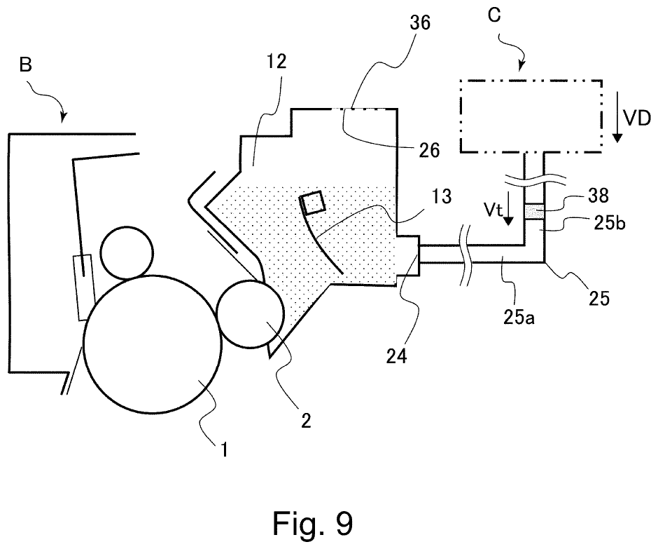

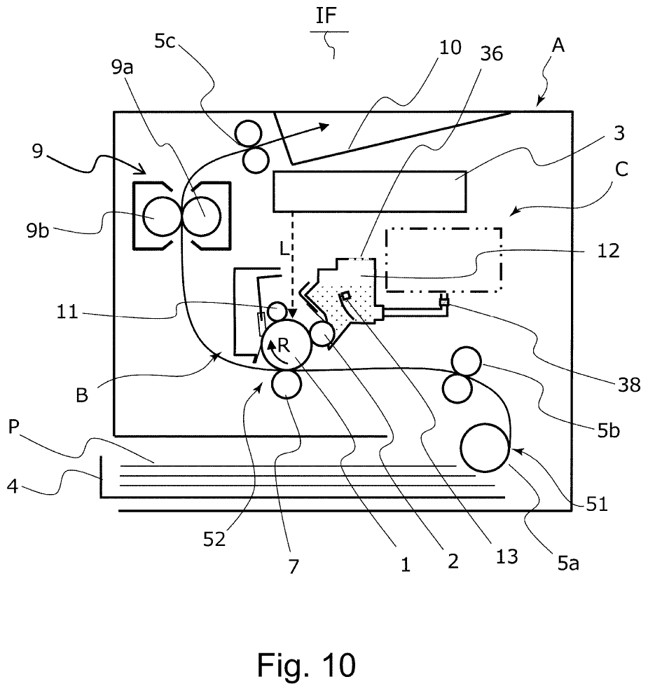

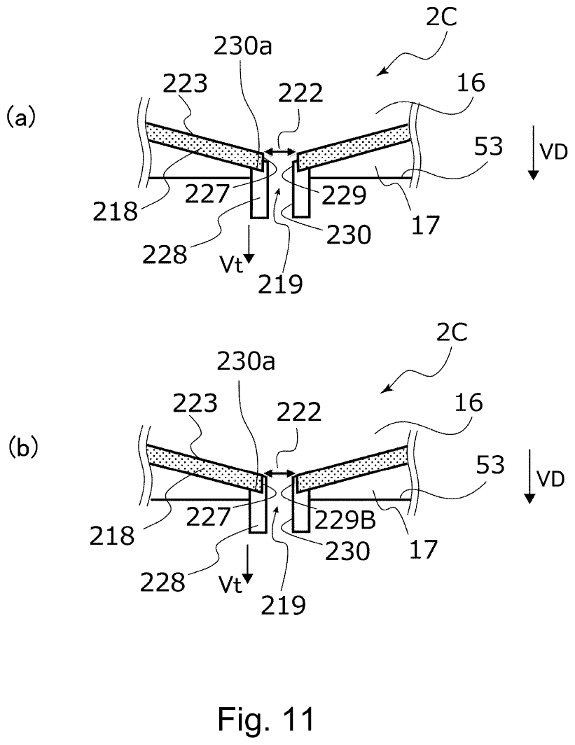

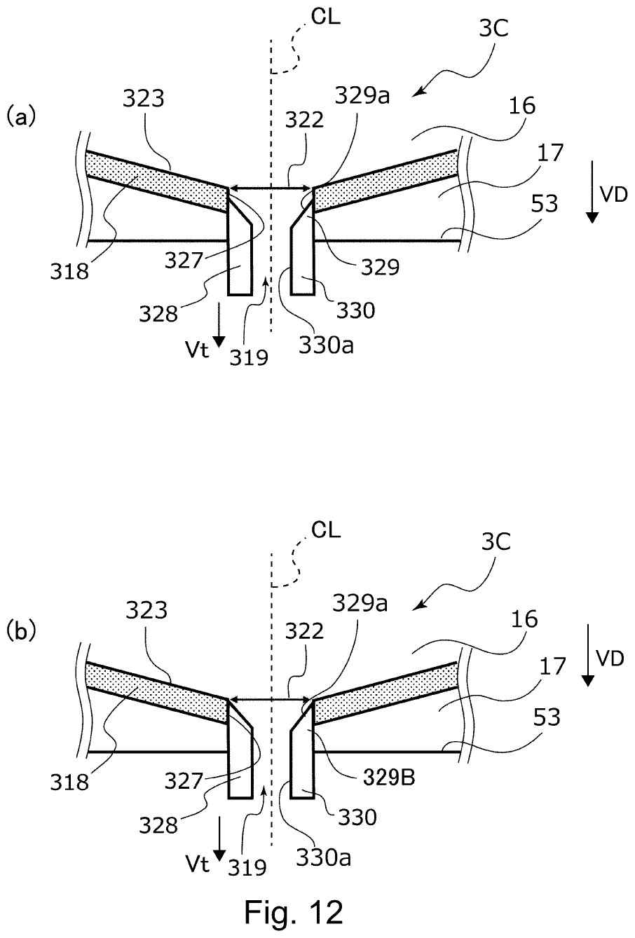

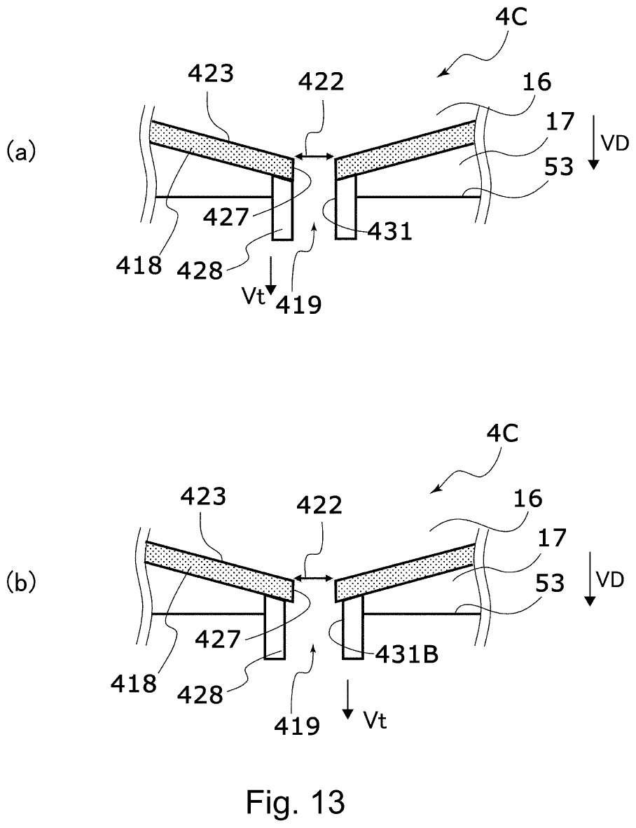

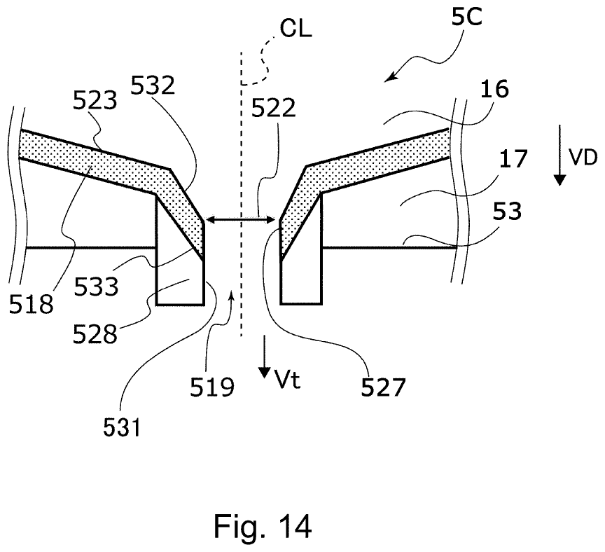

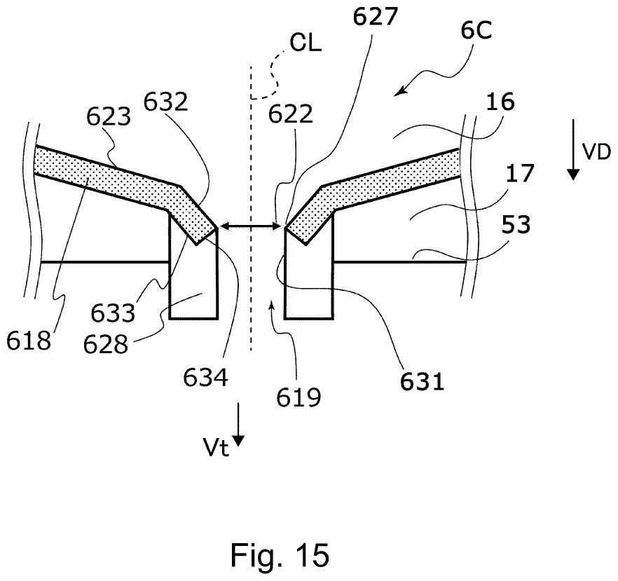

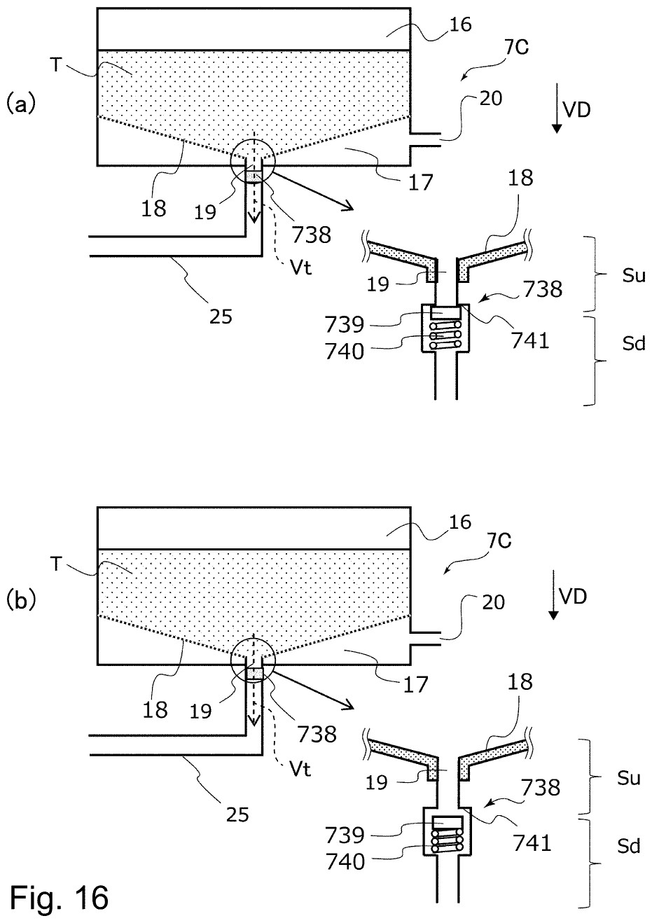

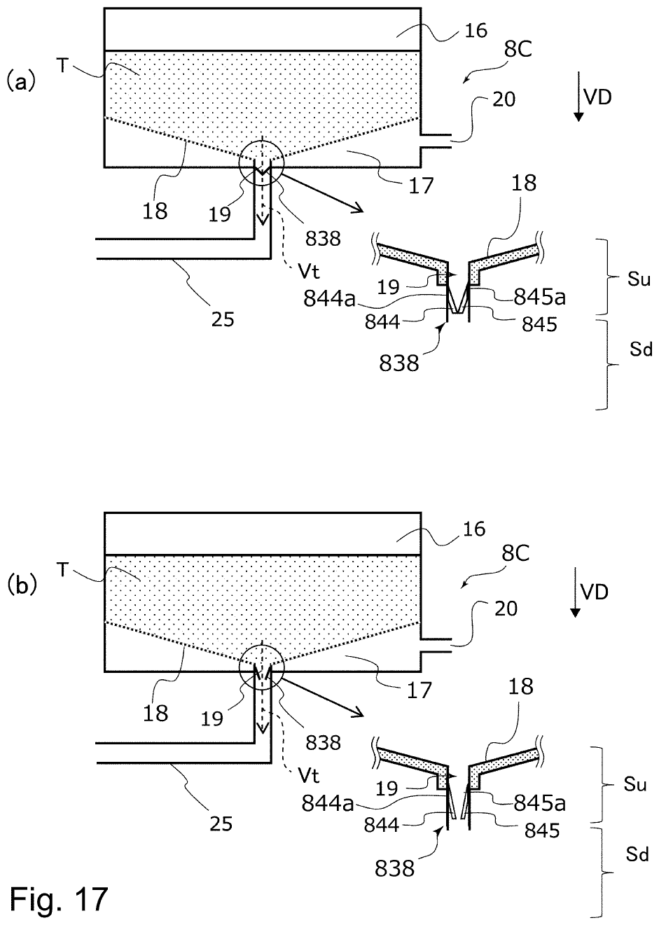

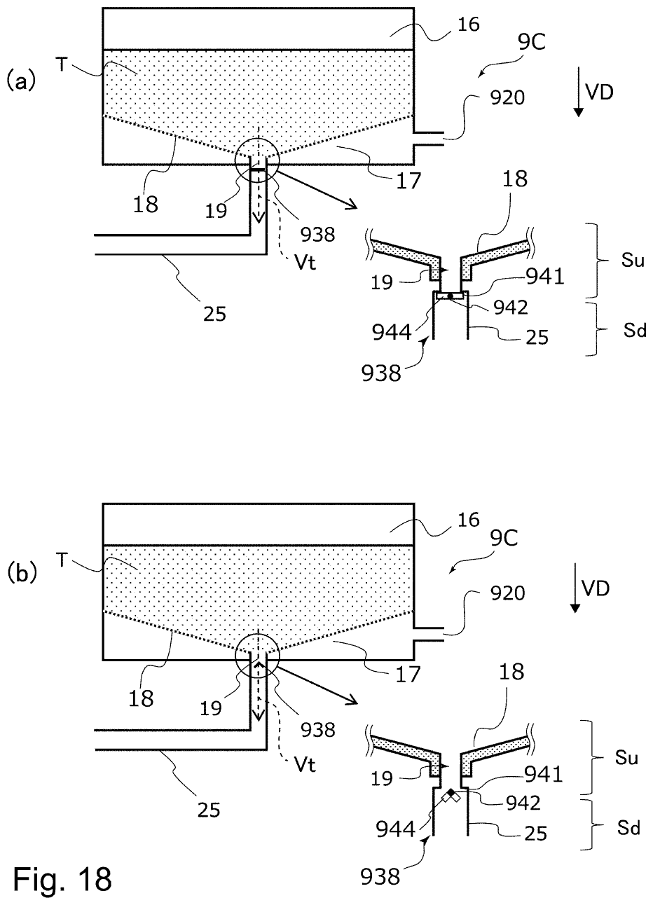

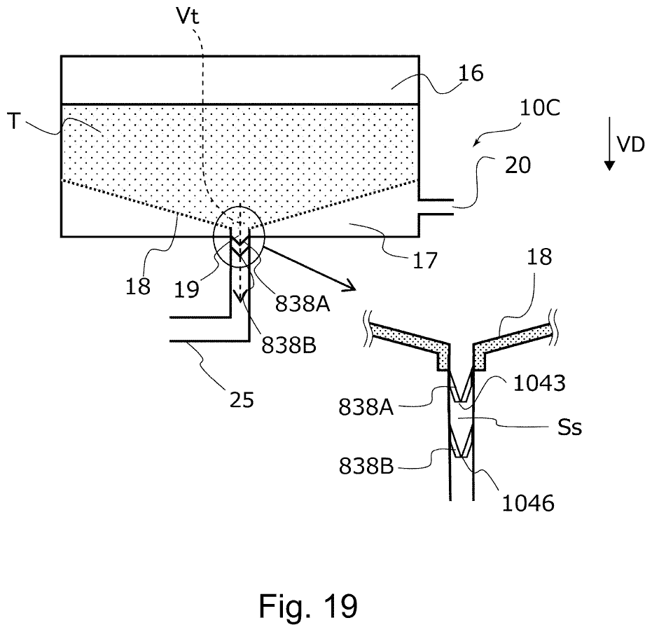

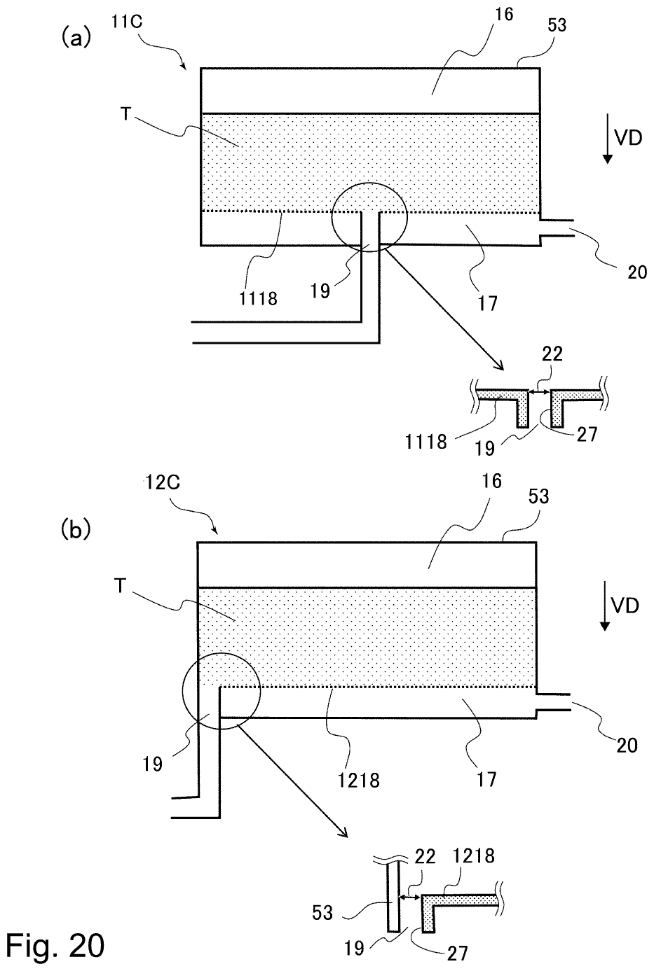

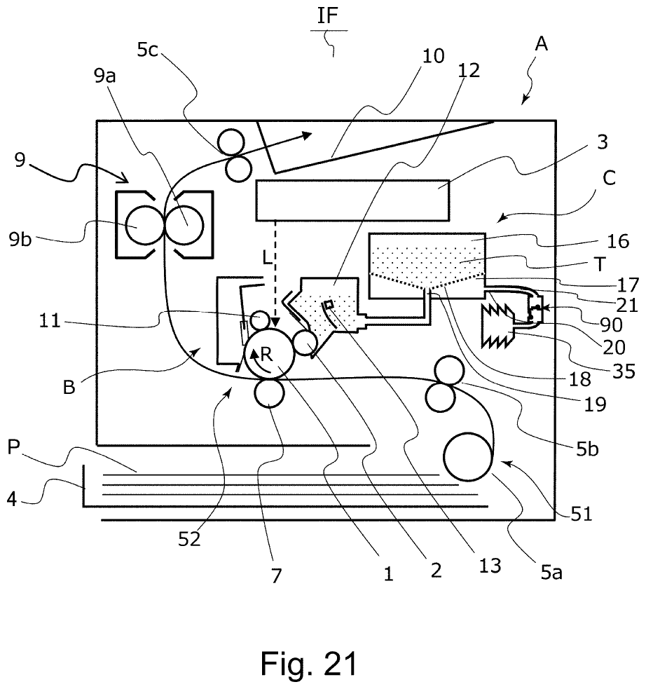

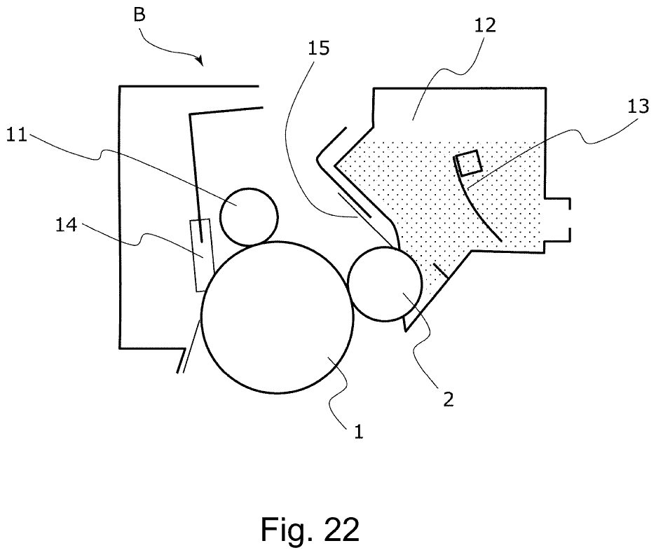

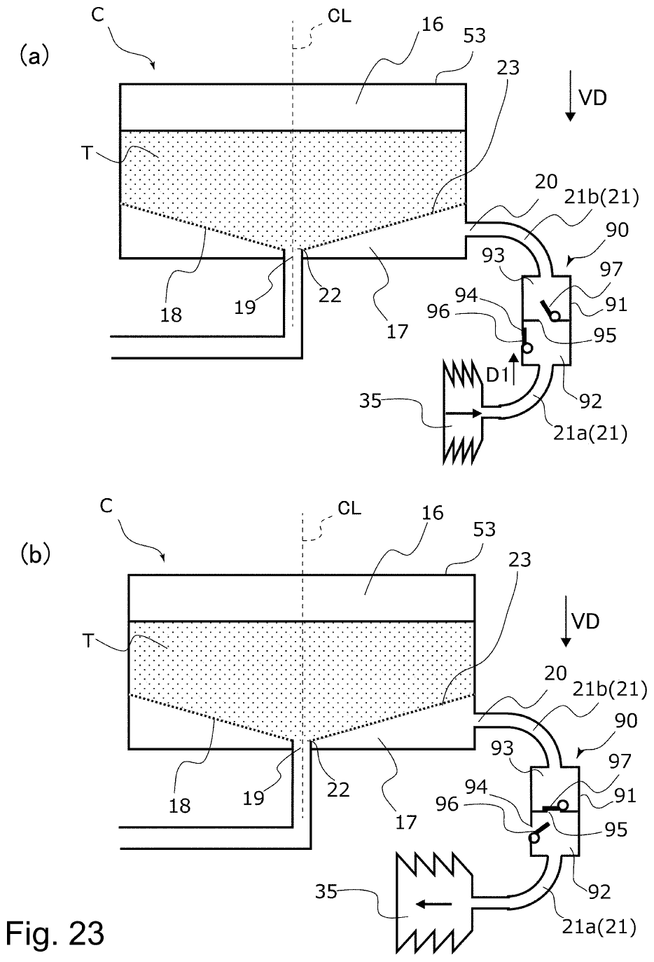

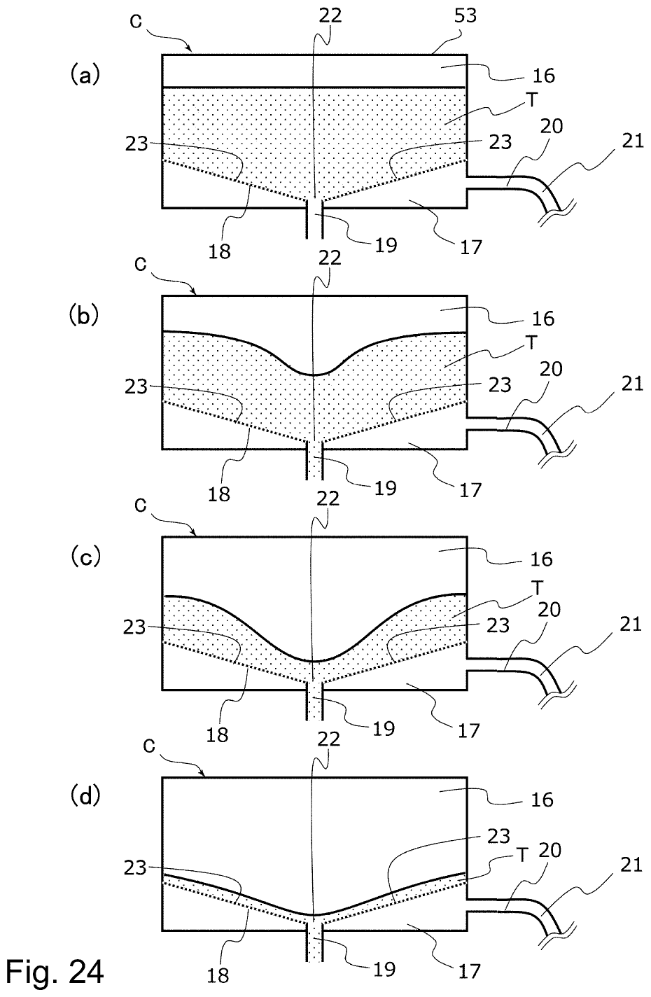

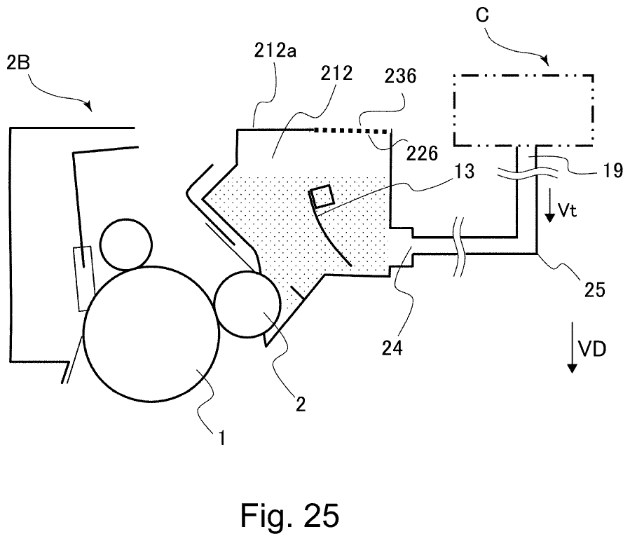

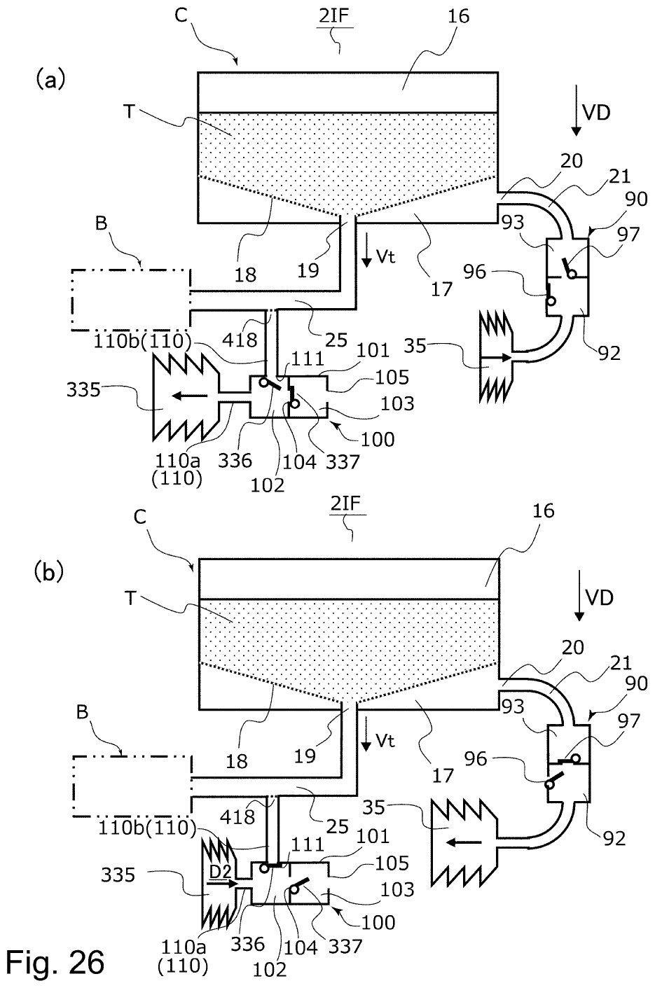

Next, using FIG. 2, a configuration of the process cartridge B will be described in detail. The process cartridge B includes, as described above, the photosensitive drum 1, the charging roller 11 and the developing roller 2 which are disposed along the photosensitive drum 1, the toner chamber 12 which accommodates the toner to be supplied to the developing roller 2, and the stirring member 13. In addition, the process cartridge B includes a cleaning blade 14 which removes the toner remaining on the photosensitive drum 1 after the toner image has been transferred to the sheet, and a developing blade 15 which regulates a layer thickness of the toner carried on the developing roller 2.

In addition, to the toner chamber 12, a toner receiving opening 24, which receives the toner replenished from the toner cartridge C, and an exhausting portion 26, through which air in the toner chamber 12 can pass, are provided. The toner receiving opening 24 is provided on a side surface of the toner chamber 12, and the exhausting portion 26 is provided on an upper surface 12a of the toner chamber 12. And so as to cover the exhausting portion 26, a filter member 36 is provided.

Incidentally, the filter member 36 is provided on an upper surface side of the exhausting portion 26 in the present Embodiment, however, the filter member 36 may be provided on a lower surface side of the exhausting portion 26. In addition, the exhausting portion 26 includes one or a plurality of openings, and the filter member 36 is configured to restrict passage of the toner and permit passage of the air. In other words, for the filter member 36, a filter with such coarseness that has air permeability but collects the toner is employed.

### [Toner Cartridge]

Next, using part (a) and part (b) of FIG. 3, a configuration of the toner cartridge C will be described. Part (a) of FIG. 3 includes a cross-sectional view illustrating the toner cartridge C and an enlarged view of a portion thereof, and part (b) of FIG. 3 is a cross-sectional view illustrating a cross-section 3B-3B in part (a) of FIG. 3. The toner cartridge C includes, as shown in part (a) of FIG. 3, a frame member 53 and a filter 18 which is disposed inside the frame member 53. To a side surface of the frame member 53, an air supplying opening 20, through which air fed from the pump 35 (see FIG. 1) is supplied, is provided. In other words, the air supplying opening 20 is a receiving opening for receiving the air.

The frame member 53 includes a toner accommodating chamber 16 which accommodates toner T and an air chamber 17 which communicates with the air supplying opening 20, and the filter 18 separates the toner accommodating chamber 16 and the air chamber 17. In other words, the air chamber 17 is adjacent to the toner accommodating chamber 16 via the filter 18. The filter 18 is a porous member made of resin fibers, for example, and sizes and density of pores thereof are such that allows the air to pass but does not allow the toner to pass. In other words, the filter 18 restricts passage of the toner and permits passage of the air in a region excluding an opening portion 22, which will be described below. In addition, the filter 18 may be constituted by filter material or non-woven fabrics, etc., which are formed by heat pressing, etc., for example.

The filter 18 includes, as shown in part (a) and part (b) of FIG. 3, an inclined portion 23 of a funnel shape, in other words, a conical shape, and the inclined portion 23 forms a bottom surface of the toner accommodating chamber 16. At a lowermost portion of the filter 18, a discharging opening 19 for discharging the toner T in the toner accommodating chamber 16 is formed. In other words, in an attitude of the toner cartridge C with arrangement of the toner accommodating chamber 16, the filter 18 and the air chamber 17 in this order from up to down with respect to a direction of gravity VD, the opening portion 22, which is an entrance of the discharging opening 19, is provided at the lowermost position of the filter 18.

Incidentally, in the description below, directions of the toner cartridge C and each member constituting the toner cartridge C are referred based on the attitude of the toner cartridge C described above, i.e., the attitude of the toner cartridge C shown in part (a) and part (b) of FIG. 3. The attitude of the toner cartridge C shown in part (a) and part (b) of FIG. 3 can also be said to be an attitude such that the discharging opening 19 faces downward with respect to the direction of gravity VD.

The opening portion 22 constitutes at least an upper end portion of the discharging opening 19. Incidentally, in the present Embodiment, the opening portion 22 is a round hole, however, the opening portion 22 may be a hole of another shape such as a polygonal shape. In the present Embodiment, the discharging opening 19 and the opening portion 22 are formed as the round hole shape by a side surface portion 27 of the filter 18. The side surface portion 27 extends downward.

In addition, the inclined portion 23 as a bottom surface portion is formed so as to approach a center line CL of the opening portion 22 as it goes downward with respect to the direction of gravity VD. In the present Embodiment, the inclined portion 23 is a tapered surface as a first tapered surface inclined downward toward the opening portion 22, however, it is not limited thereto. For example, the inclined portion 23 may be formed by a curved surface which is formed so as to approach the opening portion 22 as it goes downward with respect to the direction of gravity VD, by a combination of the curved surface and the tapered surface, or the like.

### [Mechanism of Toner Discharging]

Next, using FIG. 1 and part (a) through part (d) of FIG. 4, a mechanism by which the toner is discharged from the toner cartridge C will be described. As shown in FIG. 1, to the main assembly A, the pump 35 is provided, and the pump 35 is a reciprocating pump which has a bellows shape. The pump 35 is reciprocally driven and extended and contracted by an unshown motor, a gear and a cam.

The pump 35 is connected, via an air supplying tube 21, to the air supplying opening 20 of the toner cartridge C. The air fed from the pump 35 is supplied to the air chamber 17 of the toner cartridge C through the air supplying opening 20. And the air supplied to the air chamber 17 passes through the filter 18 and flows into the toner accommodating chamber 16.

The air which has flown into the toner accommodating chamber 16 is, while fluidizing the toner T in the toner accommodating chamber 16, discharged with the toner T from the discharging opening 19. This is because by the air supplied from the pump 35 into the toner cartridge C, an inside of the toner cartridge C becomes positive pressure. Incidentally, in the present Embodiment, the pump 35 is provided to the main assembly A, however, it is not limited thereto. For example, the pump 35 may be provided to the process cartridge B or the toner cartridge C. In addition, for the pump 35, not only the reciprocating pump such as a piston pump, a plunger pump and a diaphragm pump, but also a rotary pump such as a gear pump, a screw pump and a vane pump may be used.

Using part (a) through part (d) of FIG. 4, states in which the toner is discharged from the toner accommodating chamber 16 of the toner cartridge C will be described step-by-step. Part (a) of FIG. 4 illustrates an initial state in which the toner T in the toner accommodating chamber 16 is not discharged, and part (b), part (c) and part (d) of FIG. 4 illustrate a state in which the toner T in the toner accommodating chamber 16 is gradually decreased.

As shown in part (a) through part (c) of FIG. 4, as the toner T in the toner accommodating chamber 16 is being discharged from the discharging opening 19, a toner surface above the discharging opening 19 sinks. Along with this, the toner around the sunk toner surface collapses. In addition, since the bottom surface of the toner accommodating chamber 16 is formed by the inclined portion 23 with the opening portion 22 as the lowermost point, the toner T fluidized by the air which has flown into the toner accommodating chamber 16 from the air chamber 17 slides down toward the opening portion 22 and the discharging opening 19.

By these actions, the toner T in the toner accommodating chamber 16 is conveyed toward the discharging opening 19, and discharged from the discharging opening 19. In other words, the toner accommodated in the toner accommodating chamber 16 is discharged outside the toner cartridge C via the opening portion 22. As shown in part (d) of FIG. 4, when the toner surface becomes low as the toner T in the toner accommodating chamber 16 gets less, a conveyance amount of the toner by the toner collapsing decreases, and the toner is conveyed toward the discharging opening 19 mainly by sliding down the inclined portion 23.

At this time, if the move of the toner T stagnates in a vicinity of the opening portion 22, the move of the toner sliding down the inclined portion 23 is hindered. In the present Embodiment, the inclined portion 23 is formed by the filter 18 continuously to an edge of the opening portion 22, and the discharging opening 19 is also formed by the side surface portion 27 of the filter 18 (see part (a) of FIG. 3). Therefore, even in the periphery of the opening portion 22, the air flows from the air chamber 17 into the toner accommodating chamber 16 through the filter 18, the toner T is fluidized.

Thus, it becomes possible to suppress the stagnation of the move of the toner T in the vicinity of the opening portion 22, and to facilitate the conveyance of the toner on the inclined portion 23. By this, it becomes possible, upon discharging the toner T from the discharging opening 19, to reduce a toner amount remaining in the toner accommodating chamber 16.

Incidentally, an inclination angle of the inclined portion 23 and a flowing amount of the air supplied by the pump 35 also affect dischargeability of the toner. In order to discharge the toner T in an entire area of the toner accommodating chamber 16, it is effective to increase the inclination angle of the inclined portion 23 relative to a horizontal plane, however, if the inclination angle is too large, a toner amount which can be accommodated in the toner accommodating chamber 16 is decreased. Therefore, it is desirable to make the inclination angle of the inclined portion 23 as small as possible while making it be capable of discharging the toner T in the entire area of the toner accommodating chamber 16. For these parameters, design values are to be selected according to a required toner discharging speed, for example, however, in any conditions, by using the configuration in the present Embodiment, it becomes possible to obtain the effect to reduce the toner amount remaining in the toner accommodating chamber 16.

In addition, as a Modified Example 1 of the present Embodiment, it may be configured that, as shown in FIG. 5, the discharging opening 19 is provided at an end portion of the toner accommodating chamber 16. In such a configuration as well, since air can be flown to an edge of an opening portion 22 in an inclined portion 23, it becomes possible to obtain the same effect as in the configuration described above.

### [Toner Sealing Configuration for the Toner Cartridge]

Next, a toner sealing configuration for the toner cartridge C will be described using part (a) through part (c) of FIG. 6. In the present Embodiment, as shown in part (a) of FIG. 6, a pressure response portion 38 is provided downstream of the discharging opening 19 in a toner discharging direction Vt. Incidentally, the pressure response portion 38 may be provided, as in a Modified Example 2 of the present Embodiment shown in part (c) of FIG. 6, of a conveyance passage 25 communicating with the discharging opening 19, on a closer side to the process cartridge B. The pressure response portion 38 is configured so that, upon receiving pressure from an outside, at least a portion thereof is displaceable or deformable. As described above, in the attitude of the toner cartridge C with the arrangement of the toner accommodating chamber 16, the filter 18 and the air chamber 17 in this order from up to down, the toner discharging direction Vt is parallel to the direction of gravity VD.

Here, as shown in part (a) of FIG. 6, in the toner discharging direction Vt, in which the toner T is discharged, a pressure of an upstream side of the pressure response portion 38 is defined as a pressure Pup, a pressure of a downstream side of the pressure response portion 38 is defined as a pressure Pdown, and a predetermined pressure value is defined as a threshold value Ppre. Incidentally, the threshold value Ppre is a positive value determined by a configuration, a shape and material of the pressure response portion 38.

The threshold value Ppre in the present Embodiment is about 0.5 through 10.0 kPa. When Pup−Pdown<Ppre, as shown in part (a) of FIG. 6, the pressure response portion 38 becomes a first state of closing a space between a space Su on the upstream side of the pressure response portion 38 and a space Sd on the downstream side of the pressure response portion 38 in the toner discharging direction Vt. In addition, when Pup−Pdown≥Ppre, as shown in part (b) of FIG. 6, the pressure response portion 38 becomes a second state in which the space Su as a first space and the space Sd as a second space communicate with each other. In this manner, the pressure response portion 38 is capable of shifting to the first state and to the second state.

Here, considering a case in which the pressure response portion 38 is provided not on the process cartridge B side but on the toner cartridge C side. Incidentally, the pressure response portion 38 may be provided, in the passage connecting the toner chamber 12 of the process cartridge B and the toner accommodating chamber 16 of the toner cartridge C, to both the process cartridge B side and the toner cartridge C side. When the toner cartridge C is detached from the image forming apparatus IF, the pressure Pup and the pressure Pdown become an atmospheric pressure, respectively, and it becomes Pup=Pdown. Therefore, since it is in the relationship of Pup−Pdown<Ppre, the pressure response portion 38 becomes the first state, and seals the toner accommodating chamber 16. By this, it becomes possible to suppress the toner T in the toner accommodating chamber 16 from going outside the toner cartridge C.

On the other hand, in a state in which the toner cartridge C is attached to the image forming apparatus IF, by the air being supplied into the toner cartridge C from the air supplying opening 20 by the pump 35, the pressure Pup is increased. As a result, the pressure response portion 38 becomes the second state when the relationship of Pup−Pdown≥Ppre is satisfied. By the pressure response portion 38 becoming the second state, the space Su and the space Sd are communicated with each other, and the pressure response portion 38 can be considered as a portion of the conveyance passage 25. By using the configuration in the present Embodiment, the pressure response portion 38 becomes both a member which allows the discharging of the toner and forms a portion of the conveyance passage 25 and a sealing member which seals the toner accommodating chamber 16 and suppresses the discharging of the toner. Therefore, it becomes possible, without providing a dedicated member for sealing the toner accommodating chamber 16, to suppress the discharging of the toner with a simple and inexpensive configuration.

### [Toner Conveyance to the Process Cartridge]

Next, conveyance of the toner, which has been discharged from the toner cartridge C, to the process cartridge B will be described using part (a) and part (b) of FIG. 7. Part (a) of FIG. 7 is a cross-sectional view illustrating the process cartridge B, and part (b) of FIG. 7 is a view of the process cartridge B as viewed in the direction of gravity VD. Incidentally, in part (a) and part (b) of FIG. 7, the toner cartridge C connected to the process cartridge B is shown by a two-dot chain line.

As shown in part (a) of FIG. 7, the toner receiving opening 24 provided to the toner chamber 12 of the process cartridge B and the discharging opening 19 of the toner cartridge C are connected by the conveyance passage 25. Incidentally, in the present Embodiment, the conveyance passage 25 is configured as a portion of the process cartridge B, however, the conveyance passage 25 may be configured as a portion of the toner cartridge C or a portion of the main assembly A.

The conveyance passage 25 includes a horizontal conveyance passage 25a connected to the toner receiving opening 24 and a vertical conveyance passage 25b connected to the discharging opening 19. The discharging opening 19 and the vertical conveyance passage 25b are, by an unshown connecting structure, along with the attachment or detachment of the toner cartridge C to or from the main assembly A, connected to or disconnected from each other.

The toner discharged from the discharging opening 19 of the toner cartridge C flows with the air into the toner chamber 12 of the process cartridge B via the conveyance passage 25 and the toner receiving opening 24. At this time, the toner receiving opening 24 is positioned below the discharging opening 19 of the toner cartridge C. Therefore, the toner discharged from the discharging opening 19 is, by the air and its own weight, smoothly conveyed to the toner receiving opening 24. And the air which has flown into the toner chamber 12 passes through the exhausting portion 26 and the filter member 36 provided to the upper surface 12a of the toner chamber 12, and is exhausted outside the process cartridge B. Incidentally, at this time, since the toner is collected by the filter member 36, the toner is not discharged outside the process cartridge B.

In the present Embodiment, as shown in part (b) of FIG. 7, a cross sectional area SA1 of the filter member 36 provided to the process cartridge B is set so as to be larger than a cross sectional area SA2 of the discharging opening 19 of the toner cartridge C. Incidentally, the cross sectional area SA1 and the cross sectional area SA2 are areas in cross-sections perpendicular to conveyance directions of the air, respectively, and in the present Embodiment, are areas in a cross section along the horizontal plane. Here, a flowing speed of a fluid such as air is inversely proportional to a cross sectional area of a flow passage. Therefore, it becomes possible to make a flowing speed of the air during passing through the filter member 36 be less than a flowing speed of the air during passing through the discharging opening 19. By this, it becomes possible to suppress the toner in the toner chamber 12 from being blown up by the air, which passes through the filter member 36 and is discharged outside the process cartridge B.

And by suppressing the blowing up of the toner in the toner chamber 12, it becomes possible to suppress that the toner is adhered to the filter member 36, and to suppress reduction in a degree of the air permeability of the filter member 36. Therefore, it becomes possible to reliably exhaust the air which has flown into the toner chamber 12 via the exhausting portion 26 and the filter member 36, and to suppress reduction in conveyance performance of the toner which is conveyed with the air from the toner cartridge C to the process cartridge B. Incidentally, since the filter member 36 is provided to the upper surface 12a of the toner chamber 12, the toner collected by the filter member 36 falls off by its own weight, and it becomes possible to suppress the reduction in the degree of the air permeability of the filter member 36.

In addition, FIG. 8 is a cross-sectional view illustrating a Modified Example 3 of the present Embodiment. To a toner chamber 12M3 in the Modified Example 3, a wall portion 37 is provided. The wall portion 37 is formed so that a portion of a passage from a toner receiving opening 24 to an exhausting portion 26 is narrowed, and in the present Modified Example 3, is provided below the exhausting portion 26. In addition, the wall portion 37 is positioned at a higher position than a toner surface accommodated in the toner chamber 12M3.

By providing the wall portion 37 in this manner, even if the toner is blown up by air flowing toward the filter member 36 inside the process cartridge B, it becomes possible to reduce the toner adhered to the filter member 36 and to suppress reduction in the degree of the air permeability of the filter member 36. Incidentally, in the present Modified Example 3, the wall portion 37 is provided as a portion of a frame member of the process cartridge B, however, it is not limited thereto. For example, the wall portion 37 may be constituted by a separate member from the frame member of the process cartridge B.

### [Toner Sealing Configuration for the Process Cartridge]

Next, a toner sealing configuration for the process cartridge B will be described using FIG. 9. As described above, in the present Embodiment, the conveyance passage 25 connected to the discharging opening 19 of the toner cartridge C is configured as a portion of the process cartridge B. To the vertical conveyance passage 25b of the conveyance passage 25, the pressure response portion 38 is provided. As described above, in the toner discharging direction Vt, in which the toner T is discharged, the pressure of the upstream side of the pressure response portion 38 is defined as the pressure Pup, the pressure of the downstream side of the pressure response portion 38 is defined as the pressure Pdown, and the predetermined pressure value is defined as the threshold value Ppre. Incidentally, the threshold value Ppre is a positive value determined by a configuration, a shape and material of the pressure response portion 38.

In the state in which the process cartridge B is detached from the main assembly A of the image forming apparatus IF, the process cartridge B is connected to the outside the process cartridge B via the exhausting portion 26 and the filter member 36. Therefore, the pressure Pup and the pressure Pdown become an atmospheric pressure, respectively, and it becomes Pup=Pdown. Therefore, since it is in the relationship of Pup−Pdown<Ppre, the pressure response portion 38 becomes the first state, and seals the toner chamber 12. By this, it becomes possible to suppresses that the toner T in the toner chamber 12, via the toner receiving opening 24 and the conveyance passage 25, from going outside the process cartridge B.

### [Toner Sealing Configuration for the Image Forming Apparatus]

Next, a toner sealing configuration for the image forming apparatus IF will be described using FIG. 10. In FIG. 10, a case in which a configuration corresponding to the process cartridge B is integrally provided to the main assembly A is illustrated. In other words, in FIG. 10, the process cartridge B is provided undetachably to the main assembly A of the image forming apparatus IF.

By the way, there is a case in which, in a state in which the toner cartridge C is detached from the main assembly A, the image forming apparatus IF is moved. In this case, by vibration being applied to the image forming apparatus IF, there is a case in which the toner T in the toner chamber 12 is scattered, and the toner T scattered from the toner chamber 12 is adhered to an inside of the main assembly A. However, with the configuration in the present Embodiment, even in the state in which the process cartridge B is integrally attached to the main assembly A of the image forming apparatus IF, the process cartridge B communicates outside the process cartridge B via the exhausting portion 26 and the filter member 36.

Therefore, the pressure Pup and the pressure Pdown become an atmospheric pressure, respectively, and it becomes Pup=Pdown. Therefore, since it is in the relationship of Pup−Pdown<Ppre, the pressure response portion 38 becomes the first state, and seals the toner chamber 12. By this, it becomes possible to suppresses that the toner T in the toner chamber 12, via the toner receiving opening 24 and the conveyance passage 25, from going outside the process cartridge B.

As described above, according to the present Embodiment, it becomes possible to provide a mode of the toner cartridge C which feeds the toner with air and a mode of the image forming apparatus IF provided with the toner cartridge C. In addition, in the toner cartridge C, the air chamber 17 and the toner accommodating chamber 16 are separated by the filter 18 which restricts the passage of the toner and permits the passage of the air in the region excluding the opening portion 22. Therefore, by the air fed to the air chamber 17 by the pump 35 entering the toner accommodating chamber 16 through the filter 18, it becomes possible to fluidize the toner in the toner accommodating chamber 16 with the air.

In addition, since by the air fed to the toner cartridge C, an inside of the toner cartridge C becomes positive pressure, it becomes possible to smoothly discharge the toner in the toner accommodating chamber 16 from the discharging opening 19 together with the air. Furthermore, since the filter 18 includes the inclined portion 23, which is tapered downward toward the opening portion 22, even when the toner in the toner accommodating chamber 16 becomes less, it becomes possible to facilitate the toner to slide down the inclined portion 23 and be conveyed toward the opening portion 22. By these, it becomes possible to improve the conveyance performance and the dischargeability of the toner in the toner accommodating chamber 16, and to reduce the amount of the toner which cannot be discharged and remains in the toner accommodating chamber 16.

### Embodiment 2

Next, an Embodiment 2 of the present invention will be described, however, the Embodiment 2 is an Embodiment in which the configuration of the discharging opening 19 in the Embodiment 1 is modified. Therefore, with respect to the same configurations as in the Embodiment 1, illustrations in figures will be omitted, or the same reference numerals will be attached in the figures.

As shown in part (a) of FIG. 11, a toner cartridge 2C according to the Embodiment 2 includes the frame member 53, a filter 218 disposed inside the frame member 53, and a guide member 228. The filter 218 separates the toner accommodating chamber 16 and the air chamber 17. Incidentally, functions and material of the filter 218 are the same as those of the filter 18 in the Embodiment 1.

The filter 218 includes an inclined portion 223 having a funnel shape, and the inclined portion 223 forms a bottom surface of the toner accommodating chamber 16. At a lowermost portion of the filter 218, an opening portion 222, which is a circular hole, is formed. The opening portion 222 is formed by a side surface portion 227 of the filter 218. To the filter 218, by adhesion, welding, etc., the guide member 228 having an approximately cylindrical shape is attached. The guide member 228 is configured so as to restrict the passage of the toner and to restrict the passage of the air as well, and constitutes a portion of a wall surface forming the air chamber 17. In addition, the guide member 228 guides the passage of the toner. Incidentally, the guide member 228 is constituted by resin formed through injection molding, for example, however, it is not limited thereto.

As shown in part (a) of FIG. 11, the guide member 228 includes a first part 229 covering a portion of the side surface portion 227 of the filter 218 and a second part 230, which is continuous to the first part 229 and extends toward downstream in the toner discharging direction Vt, i.e., downward from the first part 229. The second part 230 includes a supporting surface 230a supporting the filter 218 from below. Incidentally, as shown in part (b) of FIG. 11, it may be configured so that a first part 229B of the guide member 228 covers an entire side surface portion 227 of the filter 218. That is, the first parts 229 and 229B of the guide member 228 cover at least a portion of the side surface portion 227.

In the case of the configuration in part (a) of FIG. 11, by the side surface portion 227 of the filter 218 which forms the opening portion 222 and the guide member 228, a discharging opening 219 through which the toner T in the toner accommodating chamber 16 is discharged is formed. In the case of the configuration in part (b) of FIG. 11, by the opening portion 222 and the guide member 228, the discharging opening 219 is formed. In other words, the opening portion 222 constitutes at least an upper end portion of the discharging opening 219. In addition, at least a portion of the discharging opening 219 is formed by the first part 229 and the second part 230 of the guide member 228.

By configuring as described above, it becomes possible to enhance rigidity in a vicinity of the opening portion 222, and suppress reduction in the toner dischargeability due to deformation of the filter 218. For example, if the filter 218 is deformed and an inclination angle of the inclined portion 223 becomes smaller to the horizontal plane, it becomes less likely for the toner T to slide down the inclined portion 223, and the toner dischargeability is reduced. However, in the present Embodiment, the side surface portion 227 forming the opening portion 222 of the filter 218 is reinforced by the first part 229 of the guide member 228, and a lower end portion of the filter 218 is supported by the supporting surface 230a of the second part 230 of the guide member 228. Therefore, it becomes possible to suppress the deformation of the filter 218, and suppress the reduction in the toner dischargeability.

In addition, since the guide member 228 does not have air permeability, it does not occur that the air supplied to the air chamber 17 directly flows, without passing through the filter 218 but through the guide member 228, into the discharging opening 219. In other words, the air supplied to the air chamber 17 is discharged, after passing through the filter 218 and through the toner accommodating chamber 16, from the discharging opening 219 with the toner T. By this, it becomes possible to suppress the reduction in the toner dischargeability. Furthermore, since at least a portion of the discharging opening 219 is formed by the guide member 228, it becomes possible to increase freedom in a shape of the discharging opening 219, and increase freedom in disposition of the conveyance passage 25 (see part (a) of FIG. 6).

### Embodiment 3

Next, an Embodiment 3 of the present invention will be described, however, the Embodiment 3 is an Embodiment in which the form of the guide member 228 in the Embodiment 2 is modified. Therefore, with respect to the same configurations as in the Embodiment 2, illustrations in figures will be omitted, or the same reference numerals will be attached in the figures.

As shown in part (a) of FIG. 12, a toner cartridge 3C according to the Embodiment 3 includes the frame member 53, a filter 318 disposed inside the frame member 53, and a guide member 328. The filter 318 separates the toner accommodating chamber 16 and the air chamber 17. Incidentally, functions and material of the filter 318 are the same as those of the filter 18 in the Embodiment 1.

The filter 318 includes an inclined portion 323 having a funnel shape, and the inclined portion 323 forms a bottom surface of the toner accommodating chamber 16. At a lowermost portion of the filter 318, an opening portion 322, which is a circular hole, is formed. The opening portion 322 is formed by a side surface portion 327 of the filter 318. To the filter 318, by adhesion, welding, etc., the guide member 328 having an approximately cylindrical shape is attached. The guide member 328 is configured so as to restrict the passage of the toner and to restrict the passage of the air as well, and constitutes a portion of a wall surface forming the air chamber 17. In addition, the guide member 328 guides the passage of the toner. Incidentally, the guide member 328 is constituted by resin formed through injection molding, for example, however, it is not limited thereto.

As shown in part (a) of FIG. 12, the guide member 328 includes a first part 329 covering a portion of the side surface portion 327 of the filter 318 and a second part 330, which is continuous to the first part 329 and extends toward downstream in the toner discharging direction Vt, i.e., downward from the first part 329. Incidentally, as shown in part (b) of FIG. 12, it may be configured so that a first part 329B of the guide member 328 covers an entire side surface portion 327 of the filter 318. That is, the first parts 329 and 329B of the guide member 328 cover at least a portion of the side surface portion 327.

In the case of the configuration in part (a) of FIG. 12, by the side surface portion 327 of the filter 318 which forms the opening portion 322 and the guide member 328, a discharging opening 319 through which the toner T in the toner accommodating chamber 16 is discharged is formed. In the case of the configuration in part (b) of FIG. 12, by the opening portion 322 and the guide member 328, the discharging opening 319 is formed. In other words, the opening portion 322 constitutes at least an upper end portion of the discharging opening 319. In addition, at least a portion of the discharging opening 319 is formed by the first part 329 and the second part 330 of the guide member 328.

In the present Embodiment, the first part 329 of the guide member 328 includes an inclined surface 329a of which an inclination angle to the horizontal plane is larger than that of the inclined portion 323 of the filter 318, and the inclined surface 329a is formed in a funnel shape. In other words, the inclined surface 329a as a second tapered surface is formed so as to approach a center line CL of the discharging opening 319 as it goes downward with respect to the direction of gravity VD, and is configured to be contactable with the toner which has passed through the opening portion 322. An inner peripheral surface 330a of the second part 330 of the guide member 328 is continuous to a downstream end of the inclined surface 329a in the toner discharging direction Vt and extends along the toner discharging direction Vt.

As described above, since the inclined surface 329a is provided to the first part 329 of the guide member 328, it becomes possible to allow the air to flow to an edge of the opening portion 322 in the inclined portion 323. In addition, since it becomes possible to allow the toner, which has fallen off from the opening portion 322, to fall further by the inclined surface 329a of the first part 329, it becomes possible to improve the toner dischargeability. Incidentally, it is preferable that the inclination angle of the inclined surface 329a is configured to be equal to or larger than an angle of repose of the toner to be used, i.e., the toner accommodated in the toner accommodating chamber 16. Furthermore, according to the present Embodiment, it becomes possible to achieve the same effect as in the Embodiment 2.

### Embodiment 4

Next, an Embodiment 4 of the present invention will be described, however, the Embodiment 4 is an Embodiment in which the form of the guide member 328 in the Embodiment 3 is modified. Therefore, with respect to the same configurations as in the Embodiment 3, illustrations in figures will be omitted, or the same reference numerals will be attached in the figures.

As shown in part (a) of FIG. 13, a toner cartridge 4C according to the Embodiment 4 includes the frame member 53, a filter 418 disposed inside the frame member 53, and a guide member 428. The filter 418 separates the toner accommodating chamber 16 and the air chamber 17. Incidentally, functions and material of the filter 418 are the same as those of the filter 18 in the Embodiment 1.

The filter 418 includes an inclined portion 423 having a funnel shape, and the inclined portion 423 as the first tapered surface forms a bottom surface of the toner accommodating chamber 16. At a lowermost portion of the filter 418, an opening portion 422, which is a circular hole, is formed. The opening portion 422 is formed by a side surface portion 427 of the filter 418. To the filter 418, by adhesion, welding, etc., the guide member 428 having an approximately cylindrical shape is attached. The guide member 428 is configured so as to restrict the passage of the toner and to restrict the passage of the air as well, and constitutes a portion of a wall surface forming the air chamber 17. In addition, the guide member 428 guides the passage of the toner. Incidentally, the guide member 428 is constituted by resin formed through injection molding, for example, however, it is not limited thereto.

The guide member 428 includes, as shown in part (a) of FIG. 13, an inner peripheral surface 431 disposed below the side surface portion 427, and the inner peripheral surface 431 extends downward along the toner discharging direction Vt and is formed so as to be flush with the side surface portion 427 of the filter 418. Incidentally, as shown in part (b) of FIG. 13, of an inner peripheral surface 431B of the guide member 428, an inner diameter may be larger than that of the side surface portion 427 (opening portion 422) of the filter 418. In other words, the inner peripheral surface 431B may be disposed with shifting outside the side surface portion 427 in a radial direction thereof. By configuring the inner peripheral surfaces 431 and 431B of the guide member 428 as shown in part (a) and part (b) of FIG. 13, the falling-off of the toner which has entered a discharging opening 419 is not inhibited by the guide member 428.

In the case of the configuration in part (a) of FIG. 13, by the side surface portion 427 of the filter 418 which forms the opening portion 422 and the inner peripheral surface 431 of the guide member 428, the discharging opening 419 through which the toner T in the toner accommodating chamber 16 is discharged is formed. Similarly, in the case of the configuration in part (b) of FIG. 13, by the side surface portion 427 of the filter 418 which forms the opening portion 422 and the inner peripheral surface 431B of the guide member 428, the discharging opening 419 is formed. In other words, the opening portion 422 constitutes at least an upper end portion of the discharging opening 419.

By configuring the guide member 428 as described above, it becomes possible to allow the air to flow to an edge of the opening portion 422 in the inclined portion 423. In addition, since it does not occur that the toner entering the discharging opening 419 from the opening portion 422 is inhibited from falling-off by the guide member 428 on a way to the discharging opening 419, it becomes possible to improve the toner dischargeability. Furthermore, according to the present Embodiment, it becomes possible to achieve the same effect as in the Embodiment 2.

### Embodiment 5

Next, an Embodiment 5 of the present invention will be described, however, the Embodiment 5 is an Embodiment in which the forms of the filter 418 and the guide member 428 in the Embodiment 4 are modified. Therefore, with respect to the same configurations as in the Embodiment 4, illustrations in a figure will be omitted, or the same reference numerals will be attached in the figure.

As shown in FIG. 14, a toner cartridge 5C according to the Embodiment 5 includes the frame member 53, a filter 518 disposed inside the frame member 53, and a guide member 528. The filter 518 separates the toner accommodating chamber 16 and the air chamber 17. Incidentally, functions and material of the filter 518 are the same as those of the filter 18 in the Embodiment 1.

The filter 518 includes a first inclined portion 523 and a second inclined portion 532 which have funnel shapes, respectively, and the first inclined portion 523 and the second inclined portion 532 form a bottom surface of the toner accommodating chamber 16. The first inclined portion 523 and the second inclined portion 532 are formed continuously to each other, and formed so as to approach a center line CL of a discharging opening 519, which will be described below, as it goes downward with respect to the direction of gravity VD. The second inclined portion 532 as a third tapered surface is provided on an inner side in a radial direction thereof than the first inclined portion 523 as the first tapered surface, and the inclination angle thereof to the horizontal plane is larger than that of the first inclined portion 523. In other words, the second inclined portion 532 is disposed between the first inclined portion 523 and an opening portion 522.

At a lowermost portion of the filter 518, the opening portion 522, which is a circular hole, is formed. The opening portion 522 is formed by a side surface portion 527 of the filter 518. To a bonding portion 533 of the filter 518, by adhesion, welding, etc., the guide member 528 having an approximately cylindrical shape is attached. The bonding portion 533 as a bonding surface is a surface on an opposite side to the second inclined portion 532. The guide member 528 is configured so as to restrict the passage of the toner and to restrict the passage of the air as well, and constitutes a portion of a wall surface forming the air chamber 17. In addition, the guide member 528 guides the passage of the toner. Incidentally, the guide member 528 is constituted by resin formed through injection molding, for example, however, it is not limited thereto.

The guide member 528 includes an inner peripheral surface 531, and the inner peripheral surface 531 extends along the toner discharging direction Vt, and is formed so as to be flush with the side surface portion 527 of the filter 518. In the present Embodiment, by the side surface portion 527 of the filter 518 which forms the opening portion 522 and the inner peripheral surface 531 of the guide member 528, the discharging opening 519 through which the toner T in the toner accommodating chamber 16 is discharged is formed. In other words, the opening portion 522 constitutes at least an upper end portion of the discharging opening 519.

As described above, the second inclined portion 532 is formed on a surface on an opposite side to the bonding portion 533. Since the filter 518 is bonded to the guide member 528 which does not have air permeability at the bonding portion 533, there is a case in which an amount of the air which permeates from the air chamber 17 to the second inclined portion 532 becomes less than an amount of the air which permeates from the air chamber 17 to the first inclined portion 523. When the amount of the air which permeates to the second inclined portion 532 is decreased, move of the toner on the second inclined portion 532 may stagnate, and the toner dischargeability may be reduced.

In the present Embodiment, however, of the second inclined portion 532, the inclination angle to the horizontal plane is larger than that of the first inclined portion 523, so that the falling-off of the toner on the second inclined portion 532 is facilitated, and it becomes possible to suppress the reduction in the dischargeability of the toner. Incidentally, it is preferable that the inclination angle of the second inclined portion 532 is configured to be equal to or larger than an angle of repose of the toner to be used, i.e., the toner accommodated in the toner accommodating chamber 16. In addition, since the bonding portion 533 is inclined along the second inclined portion 532, it becomes possible to make an area of the bonding portion 533 to be bonded to the guide member 528 larger, and it becomes possible to improve bonding strength between the filter 518 and the guide member 528. Furthermore, according to the present Embodiment, it becomes possible to achieve the same effect as in the Embodiments 2 through 4.

### Embodiment 6

Next, an Embodiment 6 of the present invention will be described, however, the Embodiment 6 is an Embodiment in which the forms of the filter 518 and the guide member 528 in the Embodiment 5 are modified. Therefore, with respect to the same configurations as in the Embodiment 5, illustrations in a figure will be omitted, or the same reference numerals will be attached in the figure.

As shown in FIG. 15, a toner cartridge 6C according to the Embodiment 6 includes the frame member 53, a filter 618 disposed inside the frame member 53, and a guide member 628. The filter 618 separates the toner accommodating chamber 16 and the air chamber 17. Incidentally, functions and material of the filter 618 are the same as those of the filter 18 in the Embodiment 1.

The filter 618 includes a first inclined portion 623 and a second inclined portion 632 which have funnel shapes, respectively, and the first inclined portion 623 and the second inclined portion 632 form a bottom surface of the toner accommodating chamber 16. The first inclined portion 623 and the second inclined portion 632 are formed continuously to each other, and formed so as to approach a center line CL of a discharging opening 619, which will be described below, as it goes downward with respect to the direction of gravity VD. The second inclined portion 632 as the third tapered surface is provided on an inner side in a radial direction thereof than the first inclined portion 623, and the inclination angle thereof to the horizontal plane is larger than that of the first inclined portion 623.

At a lowermost portion of the filter 618, the opening portion 622, which is a circular hole, is formed. The filter 618 includes a first bonding portion 633 which is inclined downward toward the center line CL of the discharging opening 619, which will be described below, and a second bonding portion 634 which is continuous to the first bonding portion 633 and inclined upward toward the center line CL. The first bonding portion 633 as a bonding surface and a first bonding surface is a surface on an opposite side to the second inclined portion 632. The second bonding portion 634 as a second bonding surface connects the first bonding portion 633 and the second inclined portion 632. The opening portion 622 of the filter 618 is formed by a boundary portion 627 between the second inclined portion 632 and the second bonding portion 634.

To the first bonding portion 633 and the second bonding portion 634 of the filter 618, by adhesion, welding, etc., the guide member 628 having an approximately cylindrical shape is attached. The guide member 628 is configured so as to restrict the passage of the toner and to restrict the passage of the air as well, and constitutes a portion of a wall surface forming the air chamber 17. In addition, the guide member 628 guides the passage of the toner. Incidentally, the guide member 628 is constituted by resin formed through injection molding, for example, however, it is not limited thereto.

The guide member 628 includes an inner peripheral surface 631, and the inner peripheral surface 631 extends along the toner discharging direction Vt and is formed so as to be flush with the boundary portion 627 of the filter 618. In the present Embodiment, by the boundary portion 627 of the filter 618 which forms the opening portion 622 and the inner peripheral surface 631 of the guide member 628, the discharging opening 619 through which the toner T in the toner accommodating chamber 16 is discharged is formed. In other words, the opening portion 622 constitutes at least an upper end portion of the discharging opening 619.

As described above, in the present Embodiment, the filter 618 includes the first bonding portion 633 and the second bonding portion 634 which are bonded to the guide member 628. These first bonding portion 633 and the second bonding portion 634 are inclined surfaces inclined to the horizontal plane and the toner discharging direction Vt, respectively, so that it becomes possible to make areas of the first bonding portion 633 and the second bonding portion 634 larger respectively. Therefore, it becomes possible to improve bonding strength between the filter 618 and the guide member 628. Furthermore, according to the present Embodiment, it becomes possible to achieve the same effect as in the Embodiments 2 through 5.

### Embodiment 7

Next, an Embodiment 7 of the present invention will be described, however, the Embodiment 7 is an Embodiment in which a first specific example of the pressure response portion 38 in the Embodiment 1 is exemplified. Therefore, with respect to the same configurations as in the Embodiment 1, illustrations in figures will be omitted, or the same reference numerals will be attached in the figures.

As shown in part (a) of FIG. 16, a toner cartridge 7C according to the Embodiment 7 includes a pressure response portion 738. The pressure response portion 738 is disposed downstream of the discharging opening 19 in the toner discharging direction Vt. The pressure response portion 738 includes a displacing member 739, an urging member 740 constituted by a compression spring, and an abutting portion 741.

The displacing member 739 is configured to be movable (displaceable) along the toner discharging direction Vt, and is a cylindrical member which has a cross sectional area, in a cross section perpendicular to the toner discharging direction Vt, larger than a cross sectional area of the discharging opening 19. The urging member 740 urges the displacing member 739 toward the abutting portion 741. The abutting portion 741 includes a surface facing on a downstream side in the toner discharging direction Vt.

Here, a pressure of the upstream side of the pressure response portion 738 in the toner discharging direction Vt is referred to as a pressure Pup, a pressure of the downstream side of the pressure response portion 738 is referred to as a pressure Pdown, and a predetermined pressure value is referred to as a threshold value Ppre. Incidentally, the threshold value Ppre is a positive value determined by a configuration, a shape and material of the pressure response portion 738.

The threshold value Ppre in the present Embodiment is about 0.5 to 10.0 kPa, however, the threshold value Ppre can be arbitrarily set by changing specifications of the urging member 740. When Pup−Pdown<Ppre, as shown in part (a) of FIG. 16, the pressure response portion 738 becomes a first state of separating a space Su on the upstream side of the pressure response portion 738 and a space Sd on the downstream side of the pressure response portion 738 in the toner discharging direction Vt. In addition, when Pup−Pdown≥Ppre, as shown in part (b) of FIG. 16, the pressure response portion 738 is in a second state in which the space Su and the space Sd communicate with each other.

That is, when the pressure response portion 738 is in the first state, by the displacing member 739 abutting the abutting portion 741 by urging force of the urging member 740, the discharging opening 19 is sealed by the displacing member 739. In addition, when the pressure response portion 738 is in the second state, the displacing member 739 is separated from the abutting portion 741 against the urging force of the urging member 740, and the discharging opening 19 and the conveyance passage 25 communicate with each other. By this, it becomes possible, from the discharging opening 19 of the toner cartridge 7C via the conveyance passage 25, to convey the toner T to the process cartridge B (see FIG. 1).

Incidentally, in the present Embodiment, the urging member 740 is constituted by the compression spring which pushes up the displacing member 739 toward the abutting portion 741, however, it is not limited thereto. For example, the urging member 740 may be constituted by a tension spring which pulls up the displacing member 739 toward the abutting portion 741. In addition, the urging member 740 may be constituted by another spring such as a plate spring and a torsion bar, or it may be constituted by an elastic member such as rubber and sponge, or by a magnet, etc., which urges the displacing member 739 with magnetic force thereof.

In addition, the pressure response portion 738 may be a check valve which is commonly used for fluids and is opened and closed by pressure, or may be a disk-type check valve or a ball-type check valve which includes a displaceable member urged by a spring, etc.

### Embodiment 8

Next, an Embodiment 8 of the present invention will be described, however, the Embodiment 8 is an Embodiment in which a second specific example of the pressure response portion 38 in the Embodiment 1 is exemplified. Therefore, with respect to the same configurations as in the Embodiment 1, illustrations in figures will be omitted, or the same reference numerals will be attached in the figures.

As shown in part (a) of FIG. 17, a toner cartridge 8C according to the Embodiment 8 includes a pressure response portion 838. The pressure response portion 838 is disposed downstream of the discharging opening 19 in the toner discharging direction Vt. The pressure response portion 838 includes a first valve element 844 and a second valve element 845. The first valve element 844 is deformed with a first fulcrum 844a as a center, and the second valve element 845 is deformed with a second fulcrum 845a as a center. The first valve element 844 and the second valve element 845 have flexibility, respectively, and are deformed so as to be contactable to or separable from each other.

Incidentally, in the present Embodiment, these first valve element 844 and the second valve element 845 are provided to the filter 18 or the conveyance passage 25, however, in the case in which the guide member is provided as in the Embodiments 2 through 6, the first valve element 844 and the second valve element 845 may be provided to the guide member.

Here, a pressure of the upstream side of the pressure response portion 838 in the toner discharging direction Vt is referred to as a pressure Pup, a pressure of the downstream side of the pressure response portion 838 is referred to as a pressure Pdown, and a predetermined pressure value is referred to as a threshold value Ppre. Incidentally, the threshold value Ppre is a positive value determined by a configuration, a shape and material of the pressure response portion 838.

The threshold value Ppre in the present Embodiment is about 0.5 to 10.0 kPa, however, by changing specifications of the first valve element 844 and the second valve element 845, the threshold value Ppre can be arbitrarily set. When Pup−Pdown<Ppre, as shown in part (a) of FIG. 17, the pressure response portion 838 becomes a first state of separating a space Su on the upstream side of the pressure response portion 838 and a space Sd on the downstream side of the pressure response portion 838 in the toner discharging direction Vt. In addition, when Pup−Pdown≥Ppre, as shown in part (b) of FIG. 17, the pressure response portion 838 is in a second state in which the space Su and the space Sd communicate with each other.

That is, when the pressure response portion 838 is in the first state, the first valve element 844 and the second valve element 845 contact each other, and the discharging opening 19 is sealed by the first valve element 844 and the second valve element 845. In addition, when the pressure response portion 838 is in the second state, the first valve element 844 and the second valve element 845 are separated from each other, and the discharging opening 19 and the conveyance passage 25 communicate with each other. By this, it becomes possible, from the discharging opening 19 of the toner cartridge 8C via the conveyance passage 25, to convey the toner T to the process cartridge B (see FIG. 1). In addition, since the pressure response portion 838 in the present Embodiment does not require an urging member such as a spring, the pressure response portion 838 can be constituted inexpensively.

Incidentally, the pressure response portion 838 may be a check valve which is commonly used for fluids and is deformed by pressure, and for example, a duckbill check valve, which is deformed along with move of the fluid, etc., may be used.

### Embodiment 9

Next, an Embodiment 9 of the present invention will be described, however, the Embodiment 9 is an Embodiment in which a third specific example of the pressure response portion 38 in the Embodiment 1 is exemplified. Therefore, with respect to the same configurations as in the Embodiment 1, illustrations in figures will be omitted, or the same reference numerals will be attached in the figures.

As shown in part (a) of FIG. 18, a toner cartridge 9C according to the Embodiment 9 includes a pressure response portion 938. The pressure response portion 938 is disposed downstream of the discharging opening 19 in the toner discharging direction Vt. The pressure response portion 938 includes a valve element 944 deformable with a fulcrum portion 942 as a center and a contacting portion 941 contactable to the valve element 944.

The fulcrum portion 942 is positioned at a center of the discharging opening 19 and the conveyance passage 25, and the valve element 944 is deformable to a disk shape as shown in part (a) of FIG. 18 or a conical shape as shown in part (b) of FIG. 18. In the state shown in part (a) of FIG. 18, the valve element 944 is in contact with the contacting portion 941. At this time, an outer diameter of the valve element 944 is larger than an inner diameter of the discharging opening 19.

Incidentally, in the present Embodiment, the valve element 944 is configured to be contactable to the contacting portion 941, which is a portion of the conveyance passage 25, however, the contacting portion 941 may not be a portion of the conveyance passage 25 but may be a portion of the filter 18. In addition, in the case in which the guide member is provided as in the Embodiments 2 through 6, the contacting portion 941 may be provided to the guide member. In addition, the fulcrum portion 942 may not be positioned at the center of the discharging opening 19 and the conveyance passage 25, but may be positioned at an end portion of a cross section of the conveyance passage 25 (flow passage).

Here, a pressure of the upstream side of the pressure response portion 938 in the toner discharging direction Vt is referred to as a pressure Pup, a pressure of the downstream side of the pressure response portion 938 is referred to as a pressure Pdown, and a predetermined pressure value is referred to as a threshold value Ppre. Incidentally, the threshold value Ppre is a positive value determined by a configuration, a shape and material of the pressure response portion 938.

The threshold value Ppre in the present Embodiment is about 0.5 to 10.0 kPa, however, the threshold value Ppre can be arbitrarily set by changing specifications of the valve element 944. When Pup−Pdown<Ppre, as shown in part (a) of FIG. 18, the pressure response portion 938 becomes a first state of separating a space Su on the upstream side of the pressure response portion 938 and a space Sd on the downstream side of the pressure response portion 938 in the toner discharging direction Vt. In addition, when Pup−Pdown>Ppre, as shown in part (b) of FIG. 18, the pressure response portion 938 is in a second state in which the space Su and the space Sd communicate with each other.

That is, when the pressure response portion 938 is in the first state, the valve element 944 is in contact with the contacting portion 941 and the discharging opening 19 is sealed by the valve element 944. In addition, when the pressure response portion 938 is in the second state, the valve element 944 is separated from the contacting portion 941, and the discharging opening 19 and the conveyance passage 25 communicate with each other. By this, it becomes possible, from the discharging opening 19 of the toner cartridge 9C via the conveyance passage 25, to convey the toner T to the process cartridge B (see FIG. 1). In addition, since the pressure response portion 938 in the present Embodiment does not require an urging member such as a spring, the pressure response portion 938 can be constituted inexpensively. In addition, since the valve element 944 seals the discharging opening 19 in the state of being in contact with the contacting portion 941, which is a fixed portion, with a simple configuration, it becomes possible to seal the toner more reliably.

Incidentally, the pressure response portion 938 may be a check valve which is commonly used for fluids and is deformed by pressure, and for example, a diaphragm check valve, etc., which seals by being in contact with surrounding members, may be used.

### Embodiment 10

Next, an Embodiment 10 of the present invention will be described, however, the Embodiment 10 is an Embodiment in which a fourth specific example of the pressure response portion 38 in the Embodiment 1 is exemplified. Therefore, with respect to the same configurations as in the Embodiment 1, illustrations in a figure will be omitted, or the same reference numerals will be attached in the figure.

As shown in FIG. 19, a toner cartridge 10C according to the Embodiment 10 includes a plurality of pressure response portions. Specifically, in the present Embodiment, the toner cartridge 10C includes two pressure response portions 838A and 838B. The pressure response portion 838A is disposed downstream of the discharging opening 19 in the toner discharging direction Vt, and the pressure response portion 838B is disposed downstream of the pressure response portion 838A in toner discharging direction Vt. The pressure response portions 838A and 838B have the same configuration as the pressure response portion 838 in the Embodiment 8, respectively.

In the toner discharging direction Vt, between the pressure response portion 838A and the pressure response portion 838B, a relatively small space Ss is formed. In a case in which the toner T in the toner accommodating chamber 16 is moved due to transportation of the toner cartridge 10C, etc., the toner T with increased impact force by being moved may press the pressure response portion 838A. This may cause a slit 1043 between two valve elements of the pressure response portion 838A to be opened momentarily and the toner T to pass through the slit 1043.

However, in the present Embodiment, the toner T which has passed through the slit 1043 in the pressure response portion 838A enters the space Ss. The space Ss is formed so as to be relatively small in volume, so that a toner amount entering the space Ss can be kept being a small amount. Therefore, force pressing the pressure response portion 838B by the toner entering the space Ss is relatively weak, so that it becomes possible to suppress that a slit 1046 of the pressure response portion 838B is opened. Therefore, it becomes possible to improve sealing effect for the toner by the pressure response portions 838A and 838B.

Incidentally, in the present Embodiment, two pressure response portions in the Embodiment 8 are used, however, three or more of pressure response portions in the Embodiment 8 may be used. In addition, instead of the pressure response portion in the Embodiment 8, the pressure response portion in the Embodiment 7 or in the Embodiment 9 may be used. Furthermore, the pressure response portions from the Embodiment 7 to the Embodiment 9 may be combined.

### Embodiment 11

Next, an Embodiment 11 of the present invention will be described, however, the Embodiment 11 is an Embodiment in which the configuration of the filter 18 in the Embodiment 1 is modified. Therefore, with respect to the same configurations as in the Embodiment 1, illustrations in figures will be omitted, or the same reference numerals will be attached in the figures.

As shown in part (a) of FIG. 20, a toner cartridge 11C according to the Embodiment 11 includes the frame member 53, a filter 1118 disposed inside the frame member 53. The filter 1118 separates the toner accommodating chamber 16 and the air chamber 17. Incidentally, functions and material of the filter 1118 are the same as those of the filter 18 in the Embodiment 1.

The filter 1118 extends in a horizontal direction perpendicular to the direction of gravity VD, and forms a bottom surface of the toner accommodating chamber 16. In addition, in a central portion of the filter 1118, the opening portion 22 is formed. In the present Embodiment, as in the Embodiment 1, the discharging opening 19 for discharging the toner in the toner accommodating chamber 16 is formed by the side surface portion 27 which forms the opening portion 22 of the filter 1118.

As described above, in the present Embodiment, the bottom surface of the toner accommodating chamber 16 is structured by the filter 1118 extending in the horizontal direction. In addition, since the opening portion 22 and the discharging opening 19 are formed by the side surface portion 27 of the filter 1118, via the filter 1118, it becomes possible to allow air to flow to an edge of the opening portion 22. By this, it becomes possible to suppress that move of the toner T stagnates in a vicinity of the opening portion 22, and upon discharging the toner T from the discharging opening 19, reduce a toner amount remaining in the toner accommodating chamber 16. For example, compared to a configuration in which an opening portion is provided to the frame member 53 and the toner is discharged outside through the opening portion, it becomes possible to reduce the toner amount remaining in the toner accommodating chamber 16.

In addition, in the present Embodiment, the opening portion 22 is provided in the central portion of the filter 1118, however, it is not limited thereto. For example, a Modified Example of the Embodiment 11 is shown in part (b) of FIG. 20. As shown in part (b) of FIG. 20, in a toner cartridge 12C according to the present Modified Example, a bottom surface of the toner accommodating chamber 16 is structured by a filter 1218 extending in the horizontal direction. At an end portion of the filter 1218, the opening portion 22 is formed, and the opening portion 22 and the discharging opening 19 are formed by the frame member 53 and the side surface portion 27 of the filter 1218.

Since the filter 1218 is formed so as to extend in the horizontal direction, the opening portion 22 can be provided at an arbitrary position in the filter 1218. In other words, dispositions of the opening portion 22 and the discharging opening 19 are not limited, and it becomes possible to configure simply and increase freedom in design. The toner in the toner accommodating chamber 16 is, by an inside of the frame member 53 in the toner cartridge 12C becoming positive pressure by air supplied from the air supplying opening 20, through the opening portion 22 and the discharging opening 19, discharged to an outside of the toner cartridge 12C.

### Embodiment 12

As shown in FIG. 21, an image forming apparatus IF includes the sheet feeding portion 51 which feeds the stacked sheet and the image forming portion 52 which forms the image on the fed sheet. In addition, the image forming apparatus IF includes the main assembly A, the process cartridge B (FIG. 22), the fixing device 9 which fixes the image transferred onto the sheet, the discharging roller pair 5c capable of discharging the sheet to the discharge tray 10, the pump 35, a valve unit 90 and the toner cartridge C.

### [Toner Cartridge]

Next, using part (a) and part (b) of FIG. 23, a configuration of the toner cartridge C will be described. Part (a) and part (b) of FIG. 23 are cross-sectional views illustrating the toner cartridge C, the pump 35 and the valve unit 90. The toner cartridge C includes, as shown in part (a) and part (b) of FIG. 23, the frame member 53 and the filter 18 disposed inside the frame member 53. To the side surface of the frame member 53, the air supplying opening 20 is provided. Incidentally, the pump 35 and the valve unit 90 will be described below, however, to the air supplying opening 20, by actions of the pump 35 and the valve unit 90, air is supplied. In other words, the air supplying opening 20 is the receiving opening for receiving the air.

The filter 18 includes, as shown in part (a) and part (b) of FIG. 23, the inclined portion 23 of a funnel shape, in other words, a conical shape, and the inclined portion 23 forms the bottom surface of the toner accommodating chamber 16. At the lowermost portion of the filter 18, the discharging opening 19 for discharging the toner T in the toner accommodating chamber 16 is formed. In other words, in the attitude of the toner cartridge C with the arrangement of the toner accommodating chamber 16, the filter 18 and the air chamber 17 in this order from up to down with respect to the direction of gravity VD, the opening portion 22, which is the entrance of the discharging opening 19, is provided at the lowermost position of the filter 18. The opening portion 22 constitutes at least an upper end portion of the discharging opening 19. Incidentally, in the present Embodiment, the opening portion 22 is a round hole, however, the opening portion 22 may be a hole of another shape such as a polygonal shape.

### [Pump and Valve Unit]

The main assembly A in the present Embodiment includes the pump 35 for supplying the air to the air supplying opening 20 of the toner cartridge C and the valve unit 90. The pump 35 as a first pump is a reciprocating pump having a bellows shape, and is reciprocally driven and extended and contracted by an unshown motor, a gear and a cam. By the pump 35 being extended and contracted and an internal volume of the pump 35 being changed in this manner, the pump 35 makes a first chamber 92 be positive pressure and negative pressure alternately.

The pump 35 is connected, via an air supplying tube 21, to the air supplying opening 20 of the toner cartridge C. To a middle of the air supplying tube 21, the valve unit 90 is provided. In other words, the air supplying tube 21 includes a first tube portion 21a, which connects the pump 35 and the valve unit 90, and a second tube portion 21b, which connects the valve unit 90 and the air supplying opening 20.

The valve unit 90 includes a valve frame member 91, a first valve 96 as an opening/closing valve and a first opening/closing valve, and a second valve 97 as a communication valve and a first communication valve. The valve frame member 91 includes a first chamber 92 as a second air chamber, which communicates with the first tube portion 21a, and a second chamber 93, which communicates with the second tube portion 21b. In other words, the air supplying tube 21 and the valve frame member 91 constitute a flow passage (first flow passage) between the pump 35 and the air supplying opening 20. To the first chamber 92, a first opening 94 is provided as an opening which communicates with an outside of the valve frame member 91, and between the first chamber 92 and the second chamber 93, a second opening 95 is provided.

The first valve 96 is configured to be capable of opening and closing the first opening 94, and the second valve 97 is configured to be capable of opening and closing the second opening 95. In more detail, the first valve 96 is, as shown in part (b) of FIG. 23, upon the pump 35 making the first chamber 92 negative pressure and the air chamber 17 positive pressure, in other words, upon the pump 35 being extended and the internal volume of the pump 35 being increased, switched to an open state for opening the first opening 94. In other words, the first valve 96 opens the first opening 94 in the open state as a first open state. This is because the first valve 96 provided to the first chamber 92 is sucked toward the first chamber 92 side, which has become negative pressure by the pump 35, and is pushed toward an inside of the first chamber 92 by air which attempts to enter from the outside of the valve frame member 91 to the first chamber 92.

In addition, the first valve 96 is, as shown in part (a) of FIG. 23, upon the pump 35 making the first chamber 92 positive pressure and the air chamber 17 negative pressure, in other words, upon the pump 35 being contracted and the internal volume of the pump 35 being decreased, switched to a closed state for closing the first opening 94. In other words, the first valve 96 closes the first opening 94 in the closed state as a first closed state. This is because the first valve 96 provided to the first chamber 92 is drawn by air which is discharged from the first chamber 92, which has become positive pressure by the pump 35, through the first opening 94 to the outside of the valve frame member 91. The first valve 96 is held, by abutting an inner wall of the first chamber 92, in the closed state.

The second valve 97 is, as shown in part (a) of FIG. 23, upon the pump 35 making the first chamber 92 positive pressure and the air chamber 17 negative pressure, switched to an open state for opening the second opening 95. In other words, the second valve 97 allows the first chamber 92 and the air chamber 17 to be communicated with each other in the open state as a communicating state and a first communicating state. This is because the second valve 97 provided to the second chamber 93 is pushed by air fed from the first chamber 92 through the second opening 95 into the second chamber 93. In addition, the second valve 97 is, as shown in part (b) of FIG. 23, upon the pump 35 making the first chamber 92 negative pressure and the air chamber 17 positive pressure, switched to a closed state for closing the second opening 95. In other words, the second valve 97 does not allow the first chamber 92 and the air chamber 17 to be communicated with each other in the closed state as a non-communicating state and a first non-communicating state. This is because the second valve 97 provided to the second chamber 93 is drawn to the first chamber 92 side, which has become negative pressure by the pump 35. The second valve 97 is held, by abutting an inner wall of the second chamber 93, in the closed state.

The first valve 96 is disposed, in a moving direction D1, which is a direction of air flow upon the air being fed by the pump 35 from the first chamber 92 toward the air chamber 17, upstream of the second valve 97. Incidentally, in the present Embodiment, the pump 35, the valve unit 90 and the air supplying tube 21 are provided to the main assembly A, however, it is not limited thereto. For example, the pump 35, the valve unit 90 and the air supplying tube 21 may be provided to the process cartridge B or the toner cartridge C. In other words, the pump 35, the valve unit 90 and the air supplying tube 21 may be provided to an arbitrary place in the main assembly A, the process cartridge B and the toner cartridge C of the image forming apparatus IF. For example, the valve unit 90 and the air supplying tube 21 may be provided to the toner cartridge C, and the pump 35 may be provided to the main assembly A. In addition, the air supplying tube 21 may be divided to the toner cartridge C and to the main assembly A at an arbitrary position.

In addition, for the pump 35, not only the reciprocating pump such as a piston pump, a plunger pump and a diaphragm pump, but also a rotary pump such as a gear pump, a screw pump and a vane pump may be used.

### [Mechanism of Toner Discharging]

Next, using FIG. 21 and part (a) through part (d) of FIG. 24, a mechanism by which the toner is discharged from the toner cartridge C will be described. FIG. 21 and part (a) through part (d) of FIG. 24 show substantially the same mechanism as shown in FIG. 1 and part (a) through part (d) of FIG. 4. The air fed from the pump 35 through the air supplying tube 21 is supplied to the air chamber 17 of the toner cartridge C through the air supplying opening 20. And the air supplied to the air chamber 17 passes through the filter 18, and flows into the toner accommodating chamber 16.

The air which has flown into the toner accommodating chamber 16 is, while fluidizing the toner T in the toner accommodating chamber 16, discharged with the toner T from the discharging opening 19. This is because by the air supplied from the pump 35 into the toner cartridge C, the inside of the toner cartridge C becomes positive pressure.

### [Operation of the Pump and the Valve Unit]

Next, using part (a) and part (b) of FIG. 23, operations of the pump 35 and the valve unit 90 will be described. Part (a) of FIG. 23 shows a state in which the pump 35 is contracted and makes the first chamber 92 positive pressure, and at this time, the first valve 96 is in the closed state and the second valve 97 is in the open state.

By the pump 35 being contracted, the air is fed from the pump 35 through the first tube portion 21a to the valve unit 90. By the first valve 96 being in the closed state, the air fed to the first chamber 92 of the valve unit 90 is not discharged through the first opening 94 to the outside. In addition, by the second valve 97 being in the open state, the first chamber 92 and the second chamber 93 communicate with each other via the second opening 95, so that the air fed to the first chamber 92 is fed, through the second opening 95, to the second chamber 93. In other words, the air fed toward the air supplying opening 20 passes through the first chamber 92.

And the air fed to the second chamber 93 is supplied, through the second tube portion 21b, to the air chamber 17 of the toner cartridge C. The air supplied to the air chamber 17 flows into the toner accommodating chamber 16 through the filter 18, and is discharged from the discharging opening 19 with the toner T.

On the other hand, part (b) of FIG. 23 shows a state in which the pump 35 is extended and makes the first chamber 92 negative pressure, and at this time, the first valve 96 is in the open state and the second valve 97 is in the closed state. By the pump 35 being extended, the pump 35 attempts to suck air. And by the first valve 96 being in the open state, air flows into the first chamber 92 through the first opening 94, and the air which has flown into the first chamber 92 is fed to the pump 35 through the first tube portion 21a. At this time, since the second valve 97 is in the closed state, it becomes possible for the pump 35 to suck the air efficiently. In other words, because the second valve 97 is closing the second opening 95, air in the toner accommodating chamber 16 is not sucked by the pump 35.

### [Clearing Method for Toner Clogging]

Here, for example, there is a case in which, by vibration being applied to the toner cartridge C upon the toner cartridge C being transported, a bulk density of the toner T in the toner accommodating chamber 16 becomes higher, and the toner becomes a clogging state near the discharging opening 19.

In the present Embodiment, as described above, upon the pump 35 making the first chamber 92 positive pressure and the air chamber 17 negative pressure, the air is fed to the air chamber 17 and the toner accommodating chamber 16 of the toner cartridge C. At this time, if the toner is clogged near the discharging opening 19 and it is in a state in which a discharging resistance of the toner is high, the air which has flown into the toner accommodating chamber 16 is not discharged through the discharging opening 19. When the air is fed into the toner accommodating chamber 16 in this state, the pressure inside the toner accommodating chamber 16 is increased.

Next, as shown in part (b) of FIG. 23, when the pump 35 is extended and the first chamber 92 becomes negative pressure, the first valve 96 becomes the open state and the second valve 97 becomes the closed state. By the toner being clogged near the discharging opening 19 and the second valve 97 becoming the closed state, even when the pump 35 makes the first chamber 92 negative pressure, the pressure in the toner accommodating chamber 16 is maintained. In addition, at this time, by the first valve 96 becoming the open state, the first opening 94 is opened, so that the pump 35 can suck outside air through the first opening 94.

In this manner, when the pump 35 is repeatedly extended and contracted, the pressure in the toner accommodating chamber 16 is increased each time the pump 35 is contracted, and the pressure is maintained even when the pump 35 is extended. As a result, when the pressure in the toner accommodating chamber 16 is increased to a degree with which the toner clogged near the discharging opening 19 can be discharged, it becomes possible for the clogged toner to be discharged and clear the toner clogging.

By the way, if the toner is adhered near the second opening 95 and the sealing performance of the second valve 97 for the second opening 95 is reduced, the pressure in the toner accommodating chamber 16 escapes from the second opening 95, and the pressure in the toner accommodating chamber 16 cannot be maintained. In the present Embodiment, however, by the filter 18 through which air passes but the toner does not pass, the toner accommodating chamber 16 and the air chamber 17 are separated. Therefore, it becomes possible to prevent that the toner flows back from the toner accommodating chamber 16, through the filter 18, into the air chamber 17, the second tube portion 21b and the second chamber 93, and to suppress reduction in the sealing performance of the second valve 97 for the second opening 95.

As described above, according to the present Embodiment, it becomes possible to provide a mode of the toner cartridge C which feeds the toner with air and a mode of the image forming apparatus IF provided with the toner cartridge C. In addition, in the toner cartridge C, the air chamber 17 and the toner accommodating chamber 16 are separated by the filter 18, which restricts the passage of the toner and permits the passage of the air in the region excluding the opening portion 22. Therefore, it becomes possible for the air fed to the air chamber 17 by the pump 35 to enter the toner accommodating chamber 16 through the filter 18, and fluidize the toner in the toner accommodating chamber 16 with the air.

In addition, since by the air fed to the toner cartridge C, the inside of the toner cartridge C becomes positive pressure, it becomes possible to smoothly discharge the toner in the toner accommodating chamber 16 from the discharging opening 19 with the air. Furthermore, since the filter 18 includes the inclined portion 23 which is tapered downward toward the opening portion 22, even when the toner in the toner accommodating chamber 16 becomes less, it becomes possible to facilitate the toner to slide down the inclined portion 23 and be conveyed toward the opening portion 22. By these, it becomes possible to improve the conveyance performance and the dischargeability of the toner in the toner accommodating chamber 16, and to reduce the amount of the toner which cannot be discharged and remains in the toner accommodating chamber 16.

In addition, between the pump 35 and the toner accommodating chamber 16, the second valve 97 is provided for maintaining the pressure in the toner accommodating chamber 16, so that even if the toner clogging occurs near the discharging opening 19, it becomes possible to increase the pressure in the toner accommodating chamber 16 until the toner clogging is cleared. By this, with an inexpensive configuration, it becomes possible to clear the toner clogging easily.

### Embodiment 13

Next, an Embodiment 13 of the present invention will be described, however, the Embodiment 13 is an Embodiment in which the configuration of the process cartridge B in the Embodiment 12 is modified. Therefore, with respect to the same configurations as in the Embodiment 12, illustrations in a figure will be omitted, or the same reference numerals will be attached in the figure.

A process cartridge 2B according to the Embodiment 13 includes, as shown in FIG. 25, a toner chamber 212. To the toner chamber 212, the toner receiving opening 24, which receives the toner replenished from the toner cartridge C, and an exhausting portion 226, through which air in the toner chamber 212 can pass, are provided. The toner receiving opening 24 is provided on a side surface of the toner chamber 212, and the exhausting portion 226 is provided on an upper surface 212a of the toner chamber 212. And so as to cover the exhausting portion 226, a filter member 236 as an exhausting filter is provided.

Incidentally, the filter member 236 is provided on the upper surface side of the exhausting portion 226 in the present Embodiment, however, the filter member 236 may be provided on a lower surface side of the exhausting portion 226. In addition, the exhausting portion 226 includes one or a plurality of openings, and the filter member 236 is configured to restrict passage of the toner and permit passage of the air. In other words, for the filter member 236, a filter with such coarseness that has air permeability but collects the toner is employed. Since the filter member 236 is provided to the upper surface 212a of the toner chamber 212, the toner collected by the filter member 236 falls off by its own weight, and it becomes possible to suppress reduction in a degree of the air permeability of the filter member 236.

The toner receiving opening 24 provided to the toner chamber 212 of the process cartridge 2B and the discharging opening 19 of the toner cartridge C are connected by the conveyance passage 25. Incidentally, in the present Embodiment, the conveyance passage 25 is configured as a portion of the process cartridge 2B, however, the conveyance passage 25 may be configured as a portion of the toner cartridge C or a portion of the main assembly A.

The toner discharged from the discharging opening 19 of the toner cartridge C flows with air into the toner chamber 212 of the process cartridge 2B via the conveyance passage 25 and the toner receiving opening 24. In a state in which the toner cartridge C is attached to the main assembly A, the toner receiving opening 24 is positioned below the discharging opening 19 of the toner cartridge C. Therefore, the toner discharged from the discharging opening 19 is, by the air and its own weight, smoothly conveyed to the toner receiving opening 24. And the air which has flown into the toner chamber 212 passes through the exhausting portion 226 and the filter member 236, which is provided to the upper surface 212a of the toner chamber 212, and is exhausted to an outside of the process cartridge 2B.

Here, even if the toner is clogged near the discharging opening 19, since the exhausting portion 226 and the filter member 236 are provided to the upper surface 212a of the toner chamber 212, it becomes possible to make a pressure on a downstream side of the discharging opening 19 in the toner discharging direction Vt be atmospheric pressure. As described above, in the attitude of the toner cartridge C with the arrangement of the toner accommodating chamber 16, the filter 18 and the air chamber 17 in this order from up to down, the toner discharging direction Vt is parallel to the direction of gravity VD. And on an upstream side of the discharging opening 19 in the toner discharging direction Vt, as described in the Embodiment 1, by the pump 35 being extended and contracted, the pressure can be increased above the atmospheric pressure.

Therefore, even in the case in which the toner cartridge C is connected to the process cartridge 2B, it becomes possible to make a pressure difference between the upstream side and the downstream side in the toner discharging direction Vt near the discharging opening 19 where the toner clogging has occurred. By this, as in the Embodiment 1, by increasing the pressure in the toner accommodating chamber 16 until the toner clogged near the discharging opening 19 can be discharged, it becomes possible to clear the toner clogging by the clogged toner being discharged.

### Embodiment 14

Next, an Embodiment 14 of the present invention will be described, however, the Embodiment 14 is an Embodiment in which, to the conveyance passage 25 in the Embodiment 13, a pump 335 and a valve unit 100 are further connected. Therefore, with respect to the same configurations as in the Embodiment 13, illustrations in figures will be omitted, or the same reference numerals will be attached in the figures.

An image forming apparatus 2IF according to the Embodiment 14 includes, as shown in part (a) and part (b) of FIG. 26, the pump 335 which is connected to the conveyance passage 25 via an air suction tube 110. The pump 335 as a suction pump is a reciprocating pump having a bellows shape, and is reciprocally driven and extended and contracted by an unshown motor, a gear and a cam. By the pump 335 being extended and contracted and an internal volume of the pump 335 being changed in this manner, the pump 335 makes a third chamber 102, which will be described below, be positive pressure and negative pressure alternately.

To a middle of the air suction tube 110, the valve unit 100 is provided. In other words, the air suction tube 110 includes a third tube portion 110a, which connects the pump 335 and the valve unit 100, and a fourth tube portion 110b, which connects the valve unit 100 and the conveyance passage 25.

In addition, to a connecting portion between the conveyance passage 25 and the fourth tube portion 110b, the filter 418 as a filter member is provided. The filter 418 is configured so as to restrict the passage of the toner and permit the passage of air. In other words, for the filter 418, a filter with such coarseness that has air permeability but collects the toner is employed. By providing the filter 418 to the connecting portion between the conveyance passage 25 and the fourth tube portion 110b, the toner conveyed to the conveyance passage 25 do not enter the fourth tube portion 110b.

The valve unit 100 includes a valve frame member 101, a third valve 336 as a second communication valve, and a fourth valve 337 as a second opening/closing valve. The valve frame member 101 includes a third chamber 102 as a third air chamber which communicates with the third tube portion 110a and the fourth tube portion 110b, and a fourth chamber 103 which communicates with the third chamber 102 via a third opening 104. In other words, the conveyance passage 25, the air suction tube 110 and the valve frame member 101 constitute a flow passage (second flow passage) between the pump 335 and the discharging opening 19. The third opening 104 as a second opening allows the third chamber 102 to communicate with an outside of the valve frame member 101. To the fourth chamber 103, a fourth opening 105, which allows the fourth chamber 103 to communicate with the outside of the valve frame member 101, is provided.

The third valve 336 is configured to be capable of opening and closing a communicating opening 111 between the third chamber 102 and the fourth tube portion 110b, and the fourth valve 337 is configured to be capable of opening and closing the third opening 104. In more detail, the third valve 336 is, as shown in part (a) of FIG. 26, upon the pump 335 making the third chamber 102 negative pressure and the toner accommodating chamber 16 positive pressure, in other words, upon the pump 335 being extended and an internal volume of the pump 335 being increased, switched to an open state for opening the communicating opening 111. In other words, the third valve 336 opens the communicating opening 111, which is a portion of the second flow passage, so as to allow the air chamber 17 and the third chamber 102 to communicate with each other in the open state as a second communicating state. This is because the third valve 336 provided to the third chamber 102 is sucked toward the third chamber 102 side, which is made to be negative pressure by the pump 335, and is pushed toward an inside of the third chamber 102 by air which attempts to enter from the fourth tube portion 110b to the third chamber 102.

In addition, the third valve 336 is, as shown in part (b) of FIG. 26, upon the pump 335 making the third chamber 102 positive pressure and the toner accommodating chamber 16 negative pressure, in other words, upon the pump 335 being contracted and the internal volume of the pump 335 being decreased, switched to a closed state for closing the communicating opening 111. In other words, the third valve 336 closes the communicating opening 111 so as not to allow the air chamber 17 and the third chamber 102 to communicate with each other in the closed state as a second non-communicating state. This is because the third valve 336 provided to the third chamber 102 is drawn by air which is discharged from the third chamber 102, which is made to be positive pressure by the pump 335, through the communicating opening 111 to the fourth tube portion 110b. The third valve 336 is held, by abutting an inner wall of the third chamber 102, in the closed state.

The fourth valve 337 is, as shown in part (b) of FIG. 26, upon the pump 335 making the third chamber 102 positive pressure and the toner accommodating chamber 16 negative pressure, switched to an open state for opening the third opening 104. In other words, the fourth valve 337 opens the third opening 104 in the open state as a second open state. This is because the fourth valve 337 provided to the fourth chamber 103 is pushed by air fed from the third chamber 102 through the third opening 104 into the fourth chamber 103. In addition, the fourth valve 337 is, as shown in part (a) of FIG. 26, upon the pump 335 making the third chamber 102 negative pressure and the toner accommodating chamber 16 positive pressure, switched to a closed state for closing the third opening 104. In other words, the fourth valve 337 closes the third opening 104 in the closed state as a second closed state. This is because the fourth valve 337 provided to the fourth chamber 103 is drawn to the third chamber 102 side, which is made to be negative pressure by the pump 335. The fourth valve 337 is held, by abutting an inner wall of the fourth chamber 103, in the closed state.

The fourth valve 337 is disposed, with respect to a moving direction D2, which is a direction of air flow upon the air being fed from the third chamber 102 toward the third opening 104, downstream of the third valve 336. Incidentally, in the present Embodiment, the pump 335, the valve unit 100 and the air suction tube 110 are provided to the main assembly A, however, it is not limited thereto. For example, the pump 335, the valve unit 100 and the air suction tube 110 may be provided to the process cartridge B or the toner cartridge C. In other words, the pump 335, the valve unit 100 and the air suction tube 110 may be provided to an arbitrary place in the main assembly A, the process cartridge B and the toner cartridge C of the image forming apparatus 2IF. For example, the valve unit 100 and the air suction tube 110 may be provided to the toner cartridge C, and the pump 335 may be provided to the main assembly A. In addition, the air suction tube 110 may be divided to the toner cartridge C and to the main assembly A at an arbitrary position.

In addition, for the pump 335, not only the reciprocating pump such as a piston pump, a plunger pump and a diaphragm pump, but also a rotary pump such as a gear pump, a screw pump and a vane pump may be used.

### [Operation of the Pump and the Valve Unit]

Next, using part (a) and part (b) of FIG. 26, operation of the pump 335 and the valve unit 100 will be described. Part (a) of FIG. 26 shows a state in which the pump 335 is extended and makes the third chamber 102 negative pressure, and at this time, the third valve 336 is in the open state and the fourth valve 337 is in the closed state. Incidentally, at this time, the pump 35 makes the first chamber 92 positive pressure, the first valve 96 is in the closed state, and the second valve 97 is in the open state.

By the pump 335 being extended, the pump 335 attempts to suck air. And by the third valve 336 becoming the open state, air flows from the conveyance passage 25 into the third chamber 102 via the fourth tube portion 110b, and the air which has flown into the third chamber 102 is fed to the pump 335 through the third tube portion 110a. In other words, air discharged from the toner accommodating chamber 16 passes through the third chamber 102. At this time, since the fourth valve 337 is in the closed state, it becomes possible for the pump 335 to suck the air efficiently.

On the other hand, part (b) of FIG. 26 shows a state in which the pump 335 is contracted and makes the third chamber 102 positive pressure, and at this time, the third valve 336 is in the closed state and the fourth valve 337 is in the open state. Incidentally, at this time, the pump 35 makes the first chamber 92 negative pressure, the first valve 96 is in the open state, and the second valve 97 is in the closed state.

By the pump 335 being contracted, the air is fed from the pump 335 through the third tube portion 110a to the valve unit 100. By the third valve 336 being in the closed state, the air fed to the third chamber 102 of the valve unit 100 is not discharged through the communicating opening 111 to the fourth tube portion 110b. In addition, by the fourth valve 337 being in the open state, the third chamber 102 and the fourth chamber 103 communicate with each other via the third opening 104, so that the air fed to the third chamber 102 is fed, through the third opening 104, to the fourth chamber 103. And the air fed to the fourth chamber 103 is discharged, via the fourth opening 105, to the outside of the valve unit 100.

### [Clearing Method for Toner Clogging]

Here, as described in the Embodiment 12, considering the case in which the toner clogging occurs at the discharging opening 19. On an upstream side of the discharging opening 19 in the toner discharging direction Vt, as described in the Embodiment 12, by the pump 35 being extended and contracted, pressure is increased.

On the other hand, as shown in part (a) of FIG. 26, when the pump 335 is extended and makes the third chamber 102 negative pressure, the pump 335 sucks the air from the conveyance passage 25 as described above. As a result, on a downstream side of the discharging opening 19 in the toner discharging direction Vt, pressure is decreased.

Next, as shown in part (b) of FIG. 26, when the pump 335 is contracted and makes the third chamber 102 positive pressure, the third valve 336 becomes the closed state and the fourth valve 337 becomes the open state. By the toner being clogged near the discharging opening 19 and the third valve 336 becoming the closed state, even if the pump 335 makes the third chamber 102 positive pressure, the pressure on the downstream side of the discharging opening 19 in the toner discharging direction Vt is maintained.

In this manner, as the pump 335 is repeatedly extended and contracted, the pressure on the downstream side in the toner discharging direction Vt is decreased each time the pump 335 is extended, and the pressure is maintained even when the pump 335 is contracted. In other words, by the pumps 35 and 335 being operated, the pressure in the toner accommodating chamber 16 is increased, and the pressure in the conveyance passage 25 on an opposite side to the toner accommodating chamber 16 across the discharging opening 19, where the toner clogging has occurred, is decreased.

By this, it becomes possible to make a pressure difference between the upstream side and the downstream side in the toner discharging direction Vt across the location of the occurrence of the toner clogging actively and quickly, and clear the toner clogging more quickly.

Incidentally, in the present Embodiment, by configuring when the pump 35 makes the first chamber 92 positive pressure, the pump 335 makes the third chamber 102 negative pressure, and when the pump 35 makes the first chamber 92 negative pressure, the pump 335 makes the third chamber 102 positive pressure, the pressure difference is maximized, however, it is not limited thereto. For example, the pumps 35 and 335 may be operated without synchronizing with each other.

In addition, in the present Embodiment, when the pump 335 makes the third chamber 102 positive pressure, since the pressure on the downstream side of the discharging opening 19 in the toner discharging direction Vt should be maintained, so that it is preferable not to provide the exhausting portion 226 and the filter member 236 to the process cartridge B as provided in the Embodiment 2.

### Other Embodiments

Incidentally, in any of the above-described Embodiments, the first valve 96 may be disposed, in the flow passage between the pump 35 and the air supplying opening 20, at any position as long as it is upstream of the second valve 97 in the moving direction D1. For example, the first valve 96 may be provided to the first tube portion 21a.

In addition, in any of the above-described Embodiments, the configuration in which, in an attitude of use in the image forming apparatus IF (2IF, the discharging opening 19 is provided at the lower portion of the frame member 53, and the toner cartridge C discharges the toner downward with respect to the direction of gravity VD is described, however, it is not limited thereto. For example, it may be configured that the discharging opening is provided to a side surface or an upper surface of the frame member 53 of the toner cartridge C, i.e., on the toner accommodating chamber 16 side, and the toner is conveyed via a passage, etc., which connects from the toner accommodating chamber 16 to the discharging opening, to an upward, a left direction, a right direction, a depth direction, or the like. Even in such a configuration, by applying the present invention thereto, it becomes possible to obtain the same effect.

Disclosure of the present Embodiments includes the following constitutions.

### (Constitution 1)

A toner cartridge comprising:
a toner accommodating chamber configured to accommodate toner;
a filter including an opening portion and configured to restrict passage of the toner and permit passage of air in a region excluding the opening portion; and
an air chamber provided with a receiving opening for receiving the air and adjacent to the toner accommodating chamber via the filter,
wherein the opening portion discharges the toner in the toner accommodating chamber toward an outside of the toner cartridge.

### (Constitution 2)

The toner cartridge according to Constitution 1, wherein in an attitude of the toner cartridge with arrangement of the toner accommodating chamber, the filter and the air chamber in this order from up to down with respect to a direction of gravity, the opening portion is provided at the lowermost position of the filter, and
wherein in a state in which the toner cartridge is in the attitude, the filter includes a bottom surface portion formed so as to be closer to the opening portion toward downward with respect to the direction of gravity and constituting a bottom surface of the toner accommodating chamber.

### (Constitution 3)

The toner cartridge according to Constitution 1, further comprising a discharging opening in communication with the toner accommodating chamber and configured to discharge the toner,
wherein in an attitude of the toner cartridge with the discharging opening facing downward with respect to a direction of gravity, the opening portion is provided at the lowermost position of the filter, and
wherein in a state in which the toner cartridge is in the attitude, the filter includes a bottom surface portion formed so as to be closer to the opening portion toward downward with respect to the direction of gravity and constituting a bottom surface of the toner accommodating chamber.

### (Constitution 4)

The toner cartridge according to Constitution 2 or 3, wherein in the state in which the toner cartridge is in the attitude, the bottom surface portion is a first tapered surface inclined downward toward the opening portion.

### (Constitution 5)

The toner cartridge according to Constitution 4, further comprising a discharging opening in communication with the toner accommodating chamber and configured to discharge the toner,
wherein in the state in which the toner cartridge is in the attitude, the opening portion constitutes at least an upper end portion of the discharging opening.

### (Constitution 6)

The toner cartridge according to Constitution 5, wherein in the state in which the toner cartridge is in the attitude, the filter includes a side surface portion forming the opening portion and extending downward, and
wherein the discharging opening is formed by the side surface portion.

### (Constitution 7)

The toner cartridge according to Constitution 5, further comprising a cylindrical guide member attached to the filter and configured to guide the passage of the toner,
wherein in the state in which the toner cartridge is in the attitude, the filter includes a side surface portion forming the opening portion and extending downward,
wherein in the state in which the toner cartridge is in the attitude, the guide member includes a first part covering at least a portion of the side surface portion of the filter and a second part extending downward from the first part, and
wherein at least a portion of the discharging opening is formed by the first part and the second part of the guide member.

### (Constitution 8)

The toner cartridge according to Constitution 7, wherein in the state in which the toner cartridge is in the attitude, the second part includes a supporting surface supporting the filter from below.

### (Constitution 9)

The toner cartridge according to Constitution 7, wherein in the state in which the toner cartridge is in the attitude, the first part includes a second tapered surface inclined downward toward a center line of the opening portion and of which an inclination angle to a horizontal plane is larger than that of the first tapered surface, and
wherein the second tapered surface is contactable with the toner which has passed through the opening portion.

### (Constitution 10)

The toner cartridge according to Constitution 9, wherein in the state in which the toner cartridge is in the attitude, the inclination angle of the second tapered surface to the horizontal plane is equal to or larger than an angle of repose of the toner accommodated in the toner accommodating chamber.

### (Constitution 11)

The toner cartridge according to Constitution 5, further comprising a cylindrical guide member attached to the filter and configured to guide the passage of the toner,
wherein in the state in which the toner cartridge is in the attitude, the filter includes a side surface portion forming the opening portion and extending downward,
wherein in the state in which the toner cartridge is in the attitude, the guide member includes an inner peripheral surface disposed below the side surface portion and disposed on the same surface as the side surface portion or outside of the side surface portion in a radial direction thereof, and
wherein the discharging opening is formed by the side surface portion and the inner peripheral surface.

### (Constitution 12)

The toner cartridge according to Constitution 11, wherein the first tapered surface is continuous to the opening portion.

### (Constitution 13)

The toner cartridge according to Constitution 11, wherein in the state in which the toner cartridge is in the attitude, the filter includes a third tapered surface inclined downward toward the center line of the opening portion, of which an inclination angle to a horizontal plane is larger than that of the first tapered surface, and disposed between the first tapered surface and the opening portion, and
wherein the filter includes a bonding surface provided on a side opposite to the third tapered surface and bonded to the guide member.

### (Constitution 14)

The toner cartridge according to Constitution 13, wherein the bonding surface is a first bonding surface, and
wherein the filter includes a second bonding surface configured to connect the first bonding surface and the third tapered surface and bonded to the guide member.

### (Constitution 15)

The toner cartridge according to Constitution 13 or 14, wherein in the state in which the toner cartridge is in the attitude, the inclination angle of the third tapered surface to the horizontal plane is equal to or lager than an angle of repose of the toner accommodated in the toner accommodating chamber.

### (Constitution 16)

The toner cartridge according to any one of Constitutions 13 to 15, wherein the guide member restricts the passage of the toner and restricts the passage of the air also.

### (Constitution 17)

The toner cartridge according to any one of Constitutions 5 to 16, further comprising a pressure response portion provided downstream of the discharging opening in a toner discharging direction in which the toner is discharged from the discharging opening,
wherein the pressure response portion is capable of shifting to a first state of closing a space between a first space on an upstream side and a second space on a downstream side of the pressure response portion in the toner discharging direction, and to a second state in which the first space and the second space communicate with each other,
wherein in the toner discharging direction, in a case in which a pressure of the upstream side of the pressure response portion is Pup, a pressure of the downstream side of the pressure response portion is Pdown and a predetermined pressure value is Ppre,
the pressure response portion becomes the first state in a case of Pup-Pdown<Ppre, and becomes the second state in a case of Pup−Pdown>Ppre.

### (Constitution 18)

The toner cartridge according to Constitution 17, wherein the pressure response portion includes a displacing member displaceable along the toner discharging direction, an abutting portion, and an urging member configured to urge the displacing member toward the abutting portion to the upstream side in the toner discharging direction, and becomes the first state by abutting of the displacing member to the abutting portion and becomes the second state by separating of the displacing member from the abutting portion against an urging force of the urging member.

### (Constitution 19)

The toner cartridge according to Constitution 17, wherein the pressure response portion includes a flexible first valve element and a flexible second valve element, and becomes the first state by contacting of the first valve element and the second valve element with each other and becomes the second state by separating of the first valve element and the second valve element from each other.

### (Constitution 20)

The toner cartridge according to Constitution 17, wherein the pressure response portion includes a valve element provided downstream of the discharging opening in the toner discharging direction and contactable to and separable from a conveyance passage through which the toner is conveyed, and becomes the first state by contacting of the valve element to the conveyance passage and becomes the second state by separating of the valve element from conveyance passage.

### (Constitution 21)

The toner cartridge according to any one of Constitutions 5 to 16, further comprising a plurality of pressure response portions provided downstream of the discharging opening in a toner discharging direction in which the toner is discharged from the discharging opening,
wherein each of the plurality of pressure response portions is capable of shifting to a first state of closing a space between a first space on an upstream side and a second space on a downstream side of the pressure response portion in the toner discharging direction, and to a second state of communicating with the first space and the second space,
wherein in the toner discharging direction, in a case in which a pressure of the upstream side of the pressure response portion is Pup, a pressure of the downstream side of the pressure response portion is Pdown and a predetermined pressure value is Ppre,
each of the pressure response portions becomes the first state in a case of Pup−Pdown<Ppre, and becomes the second state in a case of Pup−Pdown≥Ppre.

### (Constitution 22)

An image forming apparatus comprising:
a main assembly of the image forming apparatus;
a toner cartridge according to any one of Constitutions 5 to 21, the toner cartridge being detachably supported by the main assembly; and
a process cartridge to which toner is supplied from the toner cartridge,
wherein the process cartridge includes a toner chamber configured to accommodate the toner, an exhausting portion provided in the toner chamber and capable of discharging air, and a filter member configured to cover the exhausting portion, and
wherein the filter member is configured to restrict passage of the toner and permit passage of the air.

### (Constitution 23)

The image forming apparatus according to Constitution 22, wherein a cross sectional area of the filter member is larger than a cross sectional area of the discharging opening of the toner cartridge.

### (Constitution 24)

The image forming apparatus according to Constitution 22 or 23, wherein the exhausting portion is provided on an upper surface of the toner chamber.

### (Constitution 25)

The image forming apparatus according to any one of Constitutions 22 to 24, wherein the process cartridge includes a toner receiving opening configured to receive the toner supplied from the toner cartridge,
wherein in a state in which the toner cartridge is mounted on the main assembly, the toner receiving opening is positioned below the discharging opening of the toner cartridge.

### (Constitution 26)

The image forming apparatus according to any one of Constitutions 22 to 25, further comprising a pump configured to supply the air to the receiving opening of the toner cartridge.

### (Constitution 27)

A toner cartridge comprising:
a toner accommodating chamber configured to accommodate toner;
a filter configured to restrict passage of the toner and permit passage of air;
a first air chamber provided with a receiving opening for receiving the air and adjacent to the toner accommodating chamber via the filter;
a second air chamber through which the air fed toward the receiving opening passes; and
a communication valve switchable to a communicating state for communicating the first air chamber and the second air chamber and to a non-communicating state for not communicating the first air chamber and the second air chamber,
wherein the communication valve switches to the communicating state in a case in which the first air chamber is a negative pressure and the second air chamber is a positive pressure, and to the non-communicating state in a case in which the first air chamber is the positive pressure and the second air chamber is the negative pressure.

### (Constitution 28)

The toner cartridge according to Constitution 27, wherein the second air chamber includes an opening into which the air is taken from outside of the toner cartridge and an opening/closing valve provided in the opening and switchable to an open state for opening the opening and a closed state for closing the opening, and
wherein the opening/closing valve is disposed upstream of the communication valve with respect to a direction of an air flow when the air is taken toward the first air chamber from the second air chamber.

### (Constitution 29)

The toner cartridge according to Constitution 28, wherein the opening/closing valve becomes the closed state when the communication valve is in the communicating state and becomes the open state when the communication valve is in the non-communicating state.

### (Constitution 30)

The toner cartridge according to Constitution 28 or 29, wherein the second air chamber is connected to a pump configured to feed the air toward the second air chamber.

### (Constitution 31)

The toner cartridge according to Constitution 30, wherein in the case in which the first air chamber is the negative pressure and the second air chamber is the positive pressure, the air is fed to the toner accommodating chamber from the pump via the second air chamber, the receiving opening, the first air chamber and the filter, and in the case in which the first air chamber is the positive pressure and the second air chamber is the negative pressure, the air is not sucked from the pump by switching of the communication valve to the non-communicating state.

### (Constitution 32)

The toner cartridge according to any one of Constitutions 28 to 31, wherein the communication valve, the communicating state and the non-communicating state are a first communication valve, a first communicating state and a first non-communicating state, respectively, and further comprising:
a third air chamber through which the air discharged from the toner accommodating chamber passes;
a second communication valve switchable to a second communicating state for communicating the first air chamber and the third air chamber and to a second non-communicating state for not communicating the first air chamber and the third air chamber; and
a filter member provide between the second communication valve and the toner accommodating chamber,
wherein the filter is configured to restrict passage of the toner and permit passage of air, and
wherein the second communication valve switches to the second communicating state in a case in which the toner accommodating chamber is the positive pressure and the third air chamber is the negative pressure, and to the second non-communicating state in a case in which the toner accommodating chamber is the negative pressure and the third air chamber is the positive pressure.

### (Constitution 33)

The toner cartridge according to Constitution 32, wherein the opening, the open state, the closed state and the opening/closing valve are a first opening, a first open state, a first closed state and a first opening/closing valve, respectively,
wherein the third air chamber includes a second opening into which the air is taken from outside of the toner cartridge and a second opening/closing valve provided in the second opening and switchable to a second open state for opening the second opening and a second closed state for closing the second opening, and
wherein the second opening/closing valve is disposed downstream of the second communication valve with respect to a direction of an air flow when the air is taken toward the second air chamber from the third air chamber.

### (Constitution 34)

The toner cartridge according to Constitution 33, wherein the second opening/closing valve becomes the second closed state when the second communication valve is in the second communicating state and becomes the second open state when the second communication valve is in the second non-communicating state.

### (Constitution 35)

The toner cartridge according to Constitution 33 or 34, wherein the third air chamber is connected to a suction pump configured to suck the air from the third air chamber.

### (Constitution 36)

The toner cartridge according to Constitution 35, wherein the suction pump sucks the air from the third air chamber in the case in which the first air chamber is the negative pressure and the second air chamber is the positive pressure.

### (Constitution 37)

A toner cartridge comprising:
a toner accommodating chamber configured to accommodate toner;
a filter configured to restrict passage of the toner and permit passage of air;
a first air chamber provided with a receiving opening for receiving the air and adjacent to the toner accommodating chamber via the filter;
a second air chamber through which the air fed toward the receiving opening passes;
a communication valve switchable to a communicating state for communicating the first air chamber and the second air chamber and to a non-communicating state for not communicating the first air chamber and the second air chamber; and
a pump configured to feed the air toward the second air chamber,
wherein the communication valve switches to the communicating state in a case in which the first air chamber is a negative pressure and the second air chamber is a positive pressure, and to the non-communicating state in a case in which the first air chamber is the positive pressure and the second air chamber is the negative pressure.

### (Constitution 38)

An image forming apparatus comprising:
a main assembly of the image forming apparatus;
a toner cartridge according to any one of Constitutions 27 to 37, the toner cartridge being detachably supported by the main assembly; and
a process cartridge to which toner is supplied from the toner cartridge.

### (Constitution 39)

The image forming apparatus according to Constitution 38, wherein the process cartridge includes a toner chamber configured to accommodate the toner, an exhausting portion provided in the toner chamber and capable of discharging air, and an exhausting filter configured to cover the exhausting portion, and
wherein the exhausting filter is configured to restrict passage of the toner and permit passage of the air.

### (Constitution 40)

The image forming apparatus according to Constitution 39, wherein the exhausting portion is provided on an upper surface of the toner chamber.

### (Constitution 41)

The image forming apparatus according to any one of Constitutions 38 to 40, wherein the toner cartridge includes a discharging opening in communication with the toner accommodating chamber and configured to discharge the toner,
wherein the process cartridge includes a toner receiving opening configured to receive the toner supplied from the toner cartridge, and wherein in a state in which the toner cartridge is mounted on the main assembly, the toner receiving opening is positioned below the discharging opening of the toner cartridge.

### (Constitution 42)

An image forming apparatus comprising:
a main assembly of the image forming apparatus;
a toner cartridge detachably supported by the main assembly; and
a process cartridge to which toner is supplied from the toner cartridge,
wherein the toner cartridge includes
   a toner accommodating chamber configured to accommodate toner,
   a filter configured to restrict passage of the toner and permit passage of air, and
   a first air chamber provided with a receiving opening for receiving the air and adjacent to the toner accommodating chamber via the filter, and
wherein the main assembly includes
   a second air chamber through which the air fed toward the receiving opening passes; and
   a communication valve switchable to a communicating state for communicating the first air chamber and the second air chamber and to a non-communicating state for not communicating the first air chamber and the second air chamber,
   wherein the communication valve switches to the communicating state in a case in which the first air chamber is a negative pressure and the second air chamber is a positive pressure, and to the non-communicating state in a case in which the first air chamber is the positive pressure and the second air chamber is the negative pressure.

### (Constitution 43)

The image forming apparatus according to Constitution 42, wherein the second air chamber includes an opening into which the air is taken from outside of the toner cartridge and an opening/closing valve provided in the opening and switchable to an open state for opening the opening and a closed state for closing the opening, and
wherein the opening/closing valve is disposed upstream of the communication valve with respect to a direction of an air flow when the air is taken toward the first air chamber from the second air chamber.

### (Constitution 44)

The toner cartridge according to Constitution 43, wherein the opening/closing valve becomes the closed state when the communication valve is in the communicating state and becomes the open state when the communication valve is in the non-communicating state.

### (Constitution 45)

The image forming apparatus according to any one of Constitutions 42 to 44, wherein the main assembly includes a pump configured to feed the air toward the second air chamber.

### (Constitution 46)

The image forming apparatus according to Constitution 45, wherein in the case in which the first air chamber is the negative pressure and the second air chamber is the positive pressure, the air is fed to the toner accommodating chamber from the pump via the second air chamber, the receiving opening, the first air chamber and the filter, and in the case in which the first air chamber is the positive pressure and the second air chamber is the negative pressure, the air is not sucked from the pump by switching of the communication valve to the non-communicating state.

### INDUSTRIAL APPLICABILITY

According to the present invention, it becomes possible to provide the toner cartridge which conveys the toner with air and the image forming apparatus provided with the toner cartridge.

The present invention is not limited to the Embodiments described above, and various changes and variations are possible without departing from the spirit and scope of the invention. Accordingly, the following claims are attached to make public the scope of the present invention.

The present application claims priority on the basis of Japanese Patent Application No. 2023-040177 filed on Mar. 14, 2023, and Japanese Patent Application No. 2023-040178 filed on Mar. 14, 2023, which are hereby incorporated by reference herein in its entirety.

1. A toner cartridge comprising:
a toner accommodating chamber configured to accommodate toner;
a filter including an opening portion and configured to restrict passage of the toner and permit passage of air in a region excluding the opening portion; and
an air chamber provided with a receiving opening for receiving the air and adjacent to the toner accommodating chamber via the filter,
wherein the opening portion discharges the toner in the toner accommodating chamber toward an outside of the toner cartridge.

2. The toner cartridge according to claim 1, wherein in an attitude of the toner cartridge with arrangement of the toner accommodating chamber, the filter and the air chamber in this order from up to down with respect to a direction of gravity, the opening portion is provided at the lowermost position of the filter, and
wherein in a state in which the toner cartridge is in the attitude, the filter includes a bottom surface portion formed so as to be closer to the opening portion toward downward with respect to the direction of gravity and constituting a bottom surface of the toner accommodating chamber.

3. The toner cartridge according to claim 1, further comprising a discharging opening in communication with the toner accommodating chamber and configured to discharge the toner,
wherein in an attitude of the toner cartridge with the discharging opening facing downward with respect to a direction of gravity, the opening portion is provided at the lowermost position of the filter, and
wherein in a state in which the toner cartridge is in the attitude, the filter includes a bottom surface portion formed so as to be closer to the opening portion toward downward with respect to the direction of gravity and constituting a bottom surface of the toner accommodating chamber.

4. The toner cartridge according to claim 2, wherein in the state in which the toner cartridge is in the attitude, the bottom surface portion is a first tapered surface inclined downward toward the opening portion.

5. The toner cartridge according to claim 4, further comprising a discharging opening in communication with the toner accommodating chamber and configured to discharge the toner,
wherein in the state in which the toner cartridge is in the attitude, the opening portion constitutes at least an upper end portion of the discharging opening.

6. The toner cartridge according to claim 5, wherein in the state in which the toner cartridge is in the attitude, the filter includes a side surface portion forming the opening portion and extending downward, and
wherein the discharging opening is formed by the side surface portion.

7. The toner cartridge according to claim 5, further comprising a cylindrical guide member attached to the filter and configured to guide the passage of the toner,
wherein in the state in which the toner cartridge is in the attitude, the filter includes a side surface portion forming the opening portion and extending downward,
wherein in the state in which the toner cartridge is in the attitude, the guide member includes a first part covering at least a portion of the side surface portion of the filter and a second part extending downward from the first part, and
wherein at least a portion of the discharging opening is formed by the first part and the second part of the guide member.

8. The toner cartridge according to claim 7, wherein in the state in which the toner cartridge is in the attitude, the second part includes a supporting surface supporting the filter from below.

9. The toner cartridge according to claim 7, wherein in the state in which the toner cartridge is in the attitude, the first part includes a second tapered surface inclined downward toward a center line of the opening portion and of which an inclination angle to a horizontal plane is larger than that of the first tapered surface, and
wherein the second tapered surface is contactable with the toner which has passed through the opening portion.

10. The toner cartridge according to claim 9, wherein in the state in which the toner cartridge is in the attitude, the inclination angle of the second tapered surface to the horizontal plane is equal to or larger than an angle of repose of the toner accommodated in the toner accommodating chamber.

11. The toner cartridge according to claim 5, further comprising a cylindrical guide member attached to the filter and configured to guide the passage of the toner,
wherein in the state in which the toner cartridge is in the attitude, the filter includes a side surface portion forming the opening portion and extending downward,
wherein in the state in which the toner cartridge is in the attitude, the guide member includes an inner peripheral surface disposed below the side surface portion and disposed on the same surface as the side surface portion or outside of the side surface portion in a radial direction thereof, and
wherein the discharging opening is formed by the side surface portion and the inner peripheral surface.

12. The toner cartridge according to claim 11, wherein the first tapered surface is continuous to the opening portion.

13. The toner cartridge according to claim 11, wherein in the state in which the toner cartridge is in the attitude, the filter includes a third tapered surface inclined downward toward the center line of the opening portion, of which an inclination angle to a horizontal plane is larger than that of the first tapered surface, and disposed between the first tapered surface and the opening portion, and
wherein the filter includes a bonding surface provided on a side opposite to the third tapered surface and bonded to the guide member.

14. The toner cartridge according to claim 13, wherein the bonding surface is a first bonding surface, and
wherein the filter includes a second bonding surface configured to connect the first bonding surface and the third tapered surface and bonded to the guide member.

15. The toner cartridge according to claim 13, wherein in the state in which the toner cartridge is in the attitude, the inclination angle of the third tapered surface to the horizontal plane is equal to or lager than an angle of repose of the toner accommodated in the toner accommodating chamber.

16. The toner cartridge according to claim 13, wherein the guide member restricts the passage of the toner and restricts the passage of the air also.

17. The toner cartridge according to claim 5, further comprising a pressure response portion provided downstream of the discharging opening in a toner discharging direction in which the toner is discharged from the discharging opening,
wherein the pressure response portion is capable of shifting to a first state of closing a space between a first space on an upstream side and a second space on a downstream side of the pressure response portion in the toner discharging direction, and to a second state in which the first space and the second space communicate with each other,
wherein in the toner discharging direction, in a case in which a pressure of the upstream side of the pressure response portion is Pup, a pressure of the downstream side of the pressure response portion is Pdown and a predetermined pressure value is Ppre,
the pressure response portion becomes the first state in a case of Pup−Pdown<Ppre, and becomes the second state in a case of Pup−Pdown≥Ppre.

18. The toner cartridge according to claim 17, wherein the pressure response portion includes a displacing member displaceable along the toner discharging direction, an abutting portion, and an urging member configured to urge the displacing member toward the abutting portion to the upstream side in the toner discharging direction, and becomes the first state by abutting of the displacing member to the abutting portion and becomes the second state by separating of the displacing member from the abutting portion against an urging force of the urging member.

19. The toner cartridge according to claim 17, wherein the pressure response portion includes a flexible first valve element and a flexible second valve element, and becomes the first state by contacting of the first valve element and the second valve element with each other and becomes the second state by separating of the first valve element and the second valve element from each other.

20. The toner cartridge according to claim 17, wherein the pressure response portion includes a valve element provided downstream of the discharging opening in the toner discharging direction and contactable to and separable from a conveyance passage through which the toner is conveyed, and becomes the first state by contacting of the valve element to the conveyance passage and becomes the second state by separating of the valve element from conveyance passage.

21. The toner cartridge according to claim 5, further comprising a plurality of pressure response portions provided downstream of the discharging opening in a toner discharging direction in which the toner is discharged from the discharging opening,
wherein each of the plurality of pressure response portions is capable of shifting to a first state of closing a space between a first space on an upstream side and a second space on a downstream side of the pressure response portion in the toner discharging direction, and to a second state of communicating with the first space and the second space,
wherein in the toner discharging direction, in a case in which a pressure of the upstream side of the pressure response portion is Pup, a pressure of the downstream side of the pressure response portion is Pdown and a predetermined pressure value is Ppre,
each of the pressure response portions becomes the first state in a case of Pup−Pdown<Ppre, and becomes the second state in a case of Pup−Pdown≥Ppre.

22. An image forming apparatus comprising:
a main assembly of the image forming apparatus;
a toner cartridge according to claim 5, the toner cartridge being detachably supported by the main assembly; and
a process cartridge to which toner is supplied from the toner cartridge,
wherein the process cartridge includes a toner chamber configured to accommodate the toner, an exhausting portion provided in the toner chamber and capable of discharging air, and a filter member configured to cover the exhausting portion, and
wherein the filter member is configured to restrict passage of the toner and permit passage of the air.

23. The image forming apparatus according to claim 22, wherein a cross sectional area of the filter member is larger than a cross sectional area of the discharging opening of the toner cartridge.

24. The image forming apparatus according to claim 22, wherein the exhausting portion is provided on an upper surface of the toner chamber.

25. The image forming apparatus according to claim 22, wherein the process cartridge includes a toner receiving opening configured to receive the toner supplied from the toner cartridge,
wherein in a state in which the toner cartridge is mounted on the main assembly, the toner receiving opening is positioned below the discharging opening of the toner cartridge.

26. The image forming apparatus according to claim 22, further comprising a pump configured to supply the air to the receiving opening of the toner cartridge.

27. A toner cartridge comprising:
a toner accommodating chamber configured to accommodate toner;
a filter configured to restrict passage of the toner and permit passage of air;
a first air chamber provided with a receiving opening for receiving the air and adjacent to the toner accommodating chamber via the filter;
a second air chamber through which the air fed toward the receiving opening passes; and
a communication valve switchable to a communicating state for communicating the first air chamber and the second air chamber and to a non-communicating state for not communicating the first air chamber and the second air chamber,
wherein the communication valve switches to the communicating state in a case in which the first air chamber is a negative pressure and the second air chamber is a positive pressure, and to the non-communicating state in a case in which the first air chamber is the positive pressure and the second air chamber is the negative pressure.

28. The toner cartridge according to claim 27, wherein the second air chamber includes an opening into which the air is taken from outside of the toner cartridge and an opening/closing valve provided in the opening and switchable to an open state for opening the opening and a closed state for closing the opening, and
wherein the opening/closing valve is disposed upstream of the communication valve with respect to a direction of an air flow when the air is taken toward the first air chamber from the second air chamber.

29. The toner cartridge according to claim 28, wherein the opening/closing valve becomes the closed state when the communication valve is in the communicating state and becomes the open state when the communication valve is in the non-communicating state.

30. The toner cartridge according to claim 28, wherein the second air chamber is connected to a pump configured to feed the air toward the second air chamber.

31. The toner cartridge according to claim 30, wherein in the case in which the first air chamber is the negative pressure and the second air chamber is the positive pressure, the air is fed to the toner accommodating chamber from the pump via the second air chamber, the receiving opening, the first air chamber and the filter, and in the case in which the first air chamber is the positive pressure and the second air chamber is the negative pressure, the air is not sucked from the pump by switching of the communication valve to the non-communicating state.

32. The toner cartridge according to claim 28, wherein the communication valve, the communicating state and the non-communicating state are a first communication valve, a first communicating state and a first non-communicating state, respectively, and further comprising:
a third air chamber through which the air discharged from the toner accommodating chamber passes;
a second communication valve switchable to a second communicating state for communicating the first air chamber and the third air chamber and to a second non-communicating state for not communicating the first air chamber and the third air chamber; and
a filter member provide between the second communication valve and the toner accommodating chamber,
wherein the filter is configured to restrict passage of the toner and permit passage of air, and
wherein the second communication valve switches to the second communicating state in a case in which the toner accommodating chamber is the positive pressure and the third air chamber is the negative pressure, and to the second non-communicating state in a case in which the toner accommodating chamber is the negative pressure and the third air chamber is the positive pressure.

33. The toner cartridge according to claim 32, wherein the opening, the open state, the closed state and the opening/closing valve are a first opening, a first open state, a first closed state and a first opening/closing valve, respectively,
wherein the third air chamber includes a second opening into which the air is taken from outside of the toner cartridge and a second opening/closing valve provided in the second opening and switchable to a second open state for opening the second opening and a second closed state for closing the second opening, and
wherein the second opening/closing valve is disposed downstream of the second communication valve with respect to a direction of an air flow when the air is taken toward the second air chamber from the third air chamber.

34. The toner cartridge according to claim 33, wherein the second opening/closing valve becomes the second closed state when the second communication valve is in the second communicating state and becomes the second open state when the second communication valve is in the second non-communicating state.

35. The toner cartridge according to claim 33, wherein the third air chamber is connected to a suction pump configured to suck the air from the third air chamber.

36. The toner cartridge according to claim 35, wherein the suction pump sucks the air from the third air chamber in the case in which the first air chamber is the negative pressure and the second air chamber is the positive pressure.

37. A toner cartridge comprising:
a toner accommodating chamber configured to accommodate toner;
a filter configured to restrict passage of the toner and permit passage of air;
a first air chamber provided with a receiving opening for receiving the air and adjacent to the toner accommodating chamber via the filter;
a second air chamber through which the air fed toward the receiving opening passes;
a communication valve switchable to a communicating state for communicating the first air chamber and the second air chamber and to a non-communicating state for not communicating the first air chamber and the second air chamber; and
a pump configured to feed the air toward the second air chamber,
wherein the communication valve switches to the communicating state in a case in which the first air chamber is a negative pressure and the second air chamber is a positive pressure, and to the non-communicating state in a case in which the first air chamber is the positive pressure and the second air chamber is the negative pressure.

38. An image forming apparatus comprising:
a main assembly of the image forming apparatus;
a toner cartridge according to claim 27, the toner cartridge being detachably supported by the main assembly; and
a process cartridge to which toner is supplied from the toner cartridge.

39. The image forming apparatus according to claim 38, wherein the process cartridge includes a toner chamber configured to accommodate the toner, an exhausting portion provided in the toner chamber and capable of discharging air, and an exhausting filter configured to cover the exhausting portion, and
wherein the exhausting filter is configured to restrict passage of the toner and permit passage of the air.

40. The image forming apparatus according to claim 39, wherein the exhausting portion is provided on an upper surface of the toner chamber.

41. The image forming apparatus according to claim 38, wherein the toner cartridge includes a discharging opening in communication with the toner accommodating chamber and configured to discharge the toner,
wherein the process cartridge includes a toner receiving opening configured to receive the toner supplied from the toner cartridge, and
wherein in a state in which the toner cartridge is mounted on the main assembly, the toner receiving opening is positioned below the discharging opening of the toner cartridge.

42. An image forming apparatus comprising:
a main assembly of the image forming apparatus;
a toner cartridge detachably supported by the main assembly; and
a process cartridge to which toner is supplied from the toner cartridge,
wherein the toner cartridge includes
a toner accommodating chamber configured to accommodate toner,
a filter configured to restrict passage of the toner and permit passage of air, and
a first air chamber provided with a receiving opening for receiving the air and adjacent to the toner accommodating chamber via the filter, and
wherein the main assembly includes
a second air chamber through which the air fed toward the receiving opening passes; and
a communication valve switchable to a communicating state for communicating the first air chamber and the second air chamber and to a non-communicating state for not communicating the first air chamber and the second air chamber,
wherein the communication valve switches to the communicating state in a case in which the first air chamber is a negative pressure and the second air chamber is a positive pressure, and to the non-communicating state in a case in which the first air chamber is the positive pressure and the second air chamber is the negative pressure.

43. The image forming apparatus according to claim 42, wherein the second air chamber includes an opening into which the air is taken from outside of the toner cartridge and an opening/closing valve provided in the opening and switchable to an open state for opening the opening and a closed state for closing the opening, and
wherein the opening/closing valve is disposed upstream of the communication valve with respect to a direction of an air flow when the air is taken toward the first air chamber from the second air chamber.

44. The toner cartridge according to claim 43, wherein the opening/closing valve becomes the closed state when the communication valve is in the communicating state and becomes the open state when the communication valve is in the non-communicating state.

45. The image forming apparatus according to claim 42, wherein the main assembly includes a pump configured to feed the air toward the second air chamber.

46. The image forming apparatus according to claim 45, wherein in the case in which the first air chamber is the negative pressure and the second air chamber is the positive pressure, the air is fed to the toner accommodating chamber from the pump via the second air chamber, the receiving opening, the first air chamber and the filter, and in the case in which the first air chamber is the positive pressure and the second air chamber is the negative pressure, the air is not sucked from the pump by switching of the communication valve to the non-communicating state.
